(19) United States
(12) Patent Application Publication
(10) Pub. No.: US 2025/0172747 A1
(43) Pub. Date: May 29, 2025

(54) UNCOUPLED MULTICORE OPTICAL FIBER WITH ALKALI DOPED CORES

(71) Applicant: CORNING INCORPORATED, CORNING, NY (US)

(72) Inventors: Kevin Wallace Bennett, Hammondsport, NY (US); Pushkar Tandon, Painted Post, NY (US)

(21) Appl. No.: 18/937,231

(22) Filed: Nov. 5, 2024

Related U.S. Application Data
(60) Provisional application No. 63/603,207, filed on Nov. 28, 2023.

(51) Int. Cl. G02B 6/02; H04B 10/25; H04B 10/40; H04B 10/50

(52) U.S. Cl. CPC G02B 6/02042; G02B 6/02014; G02B 6/02019; H04B 10/2589; H04B 10/40; H04B 10/506

(57) ABSTRACT

Embodiments include a multicore optical fiber including: a common cladding having a refractive index Δ_{CC} and an outer radius of 70 μm to 95 μm; a coating having an outer radius of 120 μm to 127.5 μm; and a plurality of core portions; wherein at least one core portion comprises: an alkali-doped core region having a relative refractive index Δ₁ and a trench region having a relative refractive index Δ₃, wherein Δ₁>Δ_{CC}>Δ₃; an attenuation less than 0.165 dB/km, and an effective area of 75 μm² to 135 μm² at a wavelength of 1550 nm; and a cable cutoff wavelength less than or equal to 1530 nm; wherein the multicore optical fiber has a core multiplicity factor of 0.028 to 0.045; and wherein a counter-propagating crosstalk at 1550 nm between adjacent core portions is less than −40 dB per 100 km.

### CROSS REFERENCE TO RELATED APPLICATION

This application claims the benefit of priority under 35 U.S.C. § 119 of U.S. Provisional Application Ser. No. 63/603,207 filed on Nov. 28, 2023, the content of which is relied upon and incorporated herein by reference in its entirety.

### FIELD

The present disclosure pertains to optical fibers. More particularly, the present disclosure relates to uncoupled-core multicore optical fibers having alkali-doped core portions.

### BACKGROUND

Increased bandwidth requirements are driving the use of Space Division Multiplexing (SDM) in telecommunication systems. Multicore optical fibers are one class of SDM fibers. There has been a great variety of multicore optical fibers for SDM demonstrated over the last decade or so, with up to 36 core fibers demonstrated in research papers. There is a need in technological advancement in multicore optical fiber designs that allow for product realization for the marketplace.

### SUMMARY

In some embodiments, an uncoupled multicore optical fiber for counter-propagation transmission may include: a common cladding having a refractive index Δ_{CC} and an outer radius R_{CC} greater than or equal to 70 μm and less than or equal to 95 μm; a coating encircling and directly contacting the common cladding and extending from the outer radius R_{CC} to an outer radius R_{C} that may be greater than or equal to 120 μm and less than or equal to 127.5 μm; and a plurality of core portions disposed within the common cladding. In some embodiments, at least one core portion of the plurality of core portions may include: a central axis; a core region extending from the central axis, the core region comprising a relative refractive index Δ₁ relative to pure silica, wherein the core region may include an alkali dopant; a trench region encircling the core region, the trench region comprising a relative refractive index Δ₃ relative to pure silica, wherein Δ₁>Δ_{CC}>A₃; an attenuation of less than 0.165 dB/km at a wavelength of 1550 nm; an effective area greater than or equal to 75 μm² and less than or equal to 135 μm² at a wavelength of 1550 nm; and a cable cutoff wavelength less than or equal to 1530 nm. In some embodiments, the common cladding may directly contact the trench region. In some embodiments, the uncoupled multicore optical fiber may have a core multiplicity factor ranging from about 0.028 to about 0.045. In some embodiments, a counter-propagating crosstalk at 1550 nm between two adjacent core portions may be less than or equal to −40 dB per 100 km of the uncoupled multicore optical fiber.

In some embodiments, an uncoupled multicore optical fiber for counter-propagation transmission may include: a common cladding having a refractive index Δ_{CC} and an outer radius R_{CC} greater than or equal to 70 μm and less than or equal to 95 μm; a coating; and a plurality of core portions disposed within the common cladding. In some embodiments, the coating may include: a primary coating encircling and directly contacting the common cladding and extending from the outer radius R_{CC} to an outer radius R_{Cp}; and a secondary coating encircling and directly contacting the primary coating and extending from the outer radius R_{Cp} to an outer radius R_{Cs}, wherein the outer radius R_{Cs} may be greater than or equal to 120 μm and less than or equal to 127.5 μm. In some embodiments, each core portion of the plurality of core portions may include: a central axis; a core region extending from the central axis, the core region comprising a relative refractive index Δ₁ relative to pure silica, wherein the core region may include an alkali dopant; a trench region encircling the core region, the trench region comprising a relative refractive index Δ₃ relative to pure silica, wherein the common cladding may directly contact the trench region, and wherein Δ₁>Δ_{CC}>Δ₃; an attenuation of less than 0.165 dB/km at a wavelength of 1550 nm; an effective area greater than or equal to 75 μm² and less than or equal to 135 μm² at a wavelength of 1550 nm; and a cable cutoff wavelength less than or equal to 1530 nm. In some embodiments, the uncoupled multicore optical fiber may have a core multiplicity factor ranging from about 0.028 to about 0.045. In some embodiments, a counter-propagating crosstalk at 1550 nm between two adjacent core portions may be less than or equal to −40 dB per 100 km of the uncoupled multicore optical fiber.

In some embodiments, a bidirectional transmission system may include: an uncoupled multicore optical fiber described herein; a first transceiver optically coupled to a first end of the uncoupled multicore optical fiber; and a second transceiver optically coupled to a second end of the uncoupled multicore optical fiber opposite the first end of the uncoupled multicore optical fiber. In some embodiments, the first transceiver and the second transceiver may be configured to transmit signals from the first end of the uncoupled multicore optical fiber to the second end of the uncoupled multicore optical fiber via a first plurality of core portions of the uncoupled multicore optical fiber. In some embodiments, the first transceiver and the second transceiver may be further configured to transmit signals from the second end of the uncoupled multicore optical fiber to the first end of the uncoupled multicore optical fiber via a second plurality of core portions of the uncoupled multicore optical fiber. In some embodiments, the first plurality of core portions of the uncoupled multicore optical fiber may be different from the second plurality of core portions of the uncoupled multicore optical fiber.

In some embodiments, a method of bidirectional transmission over a multicore optical fiber having a first plurality of core portions and a second plurality of core portions may include: transmitting a first optical signal over at least one core portion of the first plurality of core portions in a first direction; and transmitting a second optical signal over at least one core portion of the second plurality of core portions in a second direction opposite the first direction. In some embodiments, the at least one core portion of the first plurality of core portions may include: a core region comprising an alkali dopant; and an attenuation of less than 0.165 dB/km at a wavelength of 1550 nm. In some embodiments, the at least one core portion of the second plurality of core portions comprises: a core region comprising an alkali dopant; and an attenuation of less than 0.165 dB/km at a wavelength of 1550 nm. In some embodiments, the first plurality of core portions and the second plurality of core portions may be disposed within a common cladding having an outer radius R_{CC} greater than or equal to 70 μm and less than or equal to 95 μm. In some embodiments, the multicore optical fiber may further include a coating encircling and directly contacting the common cladding, wherein an outer radius R_{C} of the coating may be greater than or equal to 120 μm and less than or equal to 127.5 μm. In some embodiments, the multicore optical fiber may have a core multiplicity factor ranging from about 0.028 to about 0.045. In some embodiments, a counter-propagating crosstalk at 1550 nm between two adjacent core portions may be less than or equal to −40 dB per 100 km of the uncoupled multicore optical fiber.

Additional features and advantages will be set forth in the detailed description which follows, and in part will be readily apparent to those skilled in the art from the description or recognized by practicing the embodiments as described in the written description and claims hereof, as well as the appended drawings.

### BRIEF DESCRIPTION OF THE DRAWINGS

The accompanying drawings are included to provide a further understanding and are incorporated in and constitute a part of this specification. The drawings illustrate one or more embodiment(s), and together with the detailed description serve to explain principles and operation of the various embodiments. As such, the disclosure will become more fully understood from the following detailed description, taken in conjunction with the accompanying figures.

FIG. 1 schematically depicts a simplified diagram of an exemplary optical system for bidirectional transmission over an uncoupled-core multicore optical fiber, according to some embodiments.

FIG. 2 schematically illustrates a radial cross section of an exemplary multicore optical fiber viewed along line II-II of FIG. 1.

FIG. 3 schematically depicts a radial cross section of an exemplary core portion of a multicore optical fiber viewed along line II-II of FIG. 1, according to some embodiments.

FIG. 4 depicts an exemplary relative refractive index profile of a core portion and surrounding common cladding of a multicore optical fiber, according to some embodiments.

FIG. 5 depicts another exemplary relative refractive index profile of a core portion and surrounding common cladding of a multicore optical fiber, according to some embodiments.

FIG. 6 schematically depicts a radial cross section of another exemplary core portion of a multicore optical fiber viewed along line II-II of FIG. 1, according to some embodiments.

FIG. 7 depicts another exemplary relative refractive index profile of a core portion and surrounding common cladding of a multicore optical fiber, according to some embodiments.

FIG. 8 illustrates impact of crosstalk on SNR performance of bidirectional (or counterpropagating) transmission, according to some embodiments.

FIG. 9 illustrates inter-core crosstalk for co-propagating transmission and inter-core crosstalk for counter-propagating transmission, according to some embodiments.

FIG. 10 illustrates the counter-propagating crosstalk for exemplary core portion designs, according to some embodiments.

FIG. 11 schematically illustrates a radial cross section of another exemplary multicore optical fiber.

FIG. 12 schematically illustrates a radial cross section of another exemplary multicore optical fiber.

FIG. 13 schematically illustrates a system for measuring co-propagating crosstalk and counter-propagating crosstalk, according to some embodiments.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure. The claims as set forth below are incorporated into and constitute part of this detailed description.

In this document, relational terms, such as first and second, top and bottom, and the like, are used to distinguish one entity or action from another entity or action, without necessarily requiring or implying any actual such relationship or order between such entities or actions.

It will be understood by one having ordinary skill in the art that construction of the described apparatus and/or components is not limited to any specific material. Exemplary embodiments disclosed herein may be formed from a wide variety of materials, unless described otherwise herein.

In this specification and in the claims which follow, reference will be made to a number of terms which shall be defined to have the following meanings:

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

A multicore optical fiber, also referred to as a multicore fiber or “MCF”, is considered for the purposes of the present disclosure to include two or more core portions disposed within a common cladding. Each core portion can be considered as having a higher index core region surrounded by one or more lower index cladding regions. As used herein, the term “inner core portion” refers to the higher index core region.

“Radial position” and/or “radial distance,” when used in reference to the radial coordinate “r” refers to radial position relative to the centerline (r=0) of each individual core portion in a multicore optical fiber. “Radial position” and/or “radial distance,” when used in reference to the radial coordinate “R” refers to radial position relative to the centerline (R=0, central fiber axis) of the multicore optical fiber.

The length dimension “micrometer” may be referred to herein as micron (or microns) or m.

The “refractive index profile” is the relationship between refractive index or relative refractive index and radial distance r from the core portion's centerline for each core portion of the multicore optical fiber. For relative refractive index profiles depicted herein as relatively sharp boundaries between various regions, normal variations in processing conditions may result in step boundaries at the interface of adjacent regions that are not sharp. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (core region and/or any of the cladding regions), it may be expressed in terms of its actual or approximate functional dependence or in terms of an average value applicable to the region. Unless otherwise specified, if the relative refractive index of a region (core region and/or any of the cladding regions) is expressed as a single value, it is understood that the relative refractive index in the region is constant, or approximately constant, and corresponds to the single value or that the single value represents an average value of a non-constant relative refractive index dependence with radial position in the region. Whether by design or a consequence of normal manufacturing variability, the dependence of relative refractive index on radial position may be sloped, curved, or otherwise non-constant.

The “relative refractive index” or “relative refractive index percent” as used herein with respect to multicore optical fibers and fiber cores of multicore optical fibers is defined according to the following equation:

$$Δ \% = 100 \frac{{n}^{2} ( r ) - {n}_{c}^{2}}{2 {n}^{2} ( r )}$$

where n(r) is the refractive index at the radial distance r from the core's centerline at a wavelength of 1550 nm, unless otherwise specified, and nₑ is 1.444, which is the refractive index of undoped silica glass at a wavelength of 1550 nm. As used herein, the relative refractive index is represented by Δ (or “delta”) or Δ % (or “delta %) and its values are given in units of “%” or “%Δ”, unless otherwise specified. Relative refractive index may also be expressed as Δ(r) or Δ(r)%. When the refractive index of a region is less than the reference index nₑ, the relative refractive index is negative and can be referred to as a trench. When the refractive index of a region is greater than the reference index nₑ, the relative refractive index is positive, and the region can be said to be raised or to have a positive index.

The average relative refractive index of a region of the multicore optical fiber can be defined according to the following equation:

$$Δ \% = \frac{{\int }_{{r}_{inner}}^{{r}_{outer}} Δ ( r ) dr}{( {r}_{outer} - {r}_{inner} )}$$

where rᵢₙₙₑᵣ is the inner radius of the region, rₒᵤₜₑᵣ is the outer radius of the region, and Δ(r) is the relative refractive index of the region.

The term “a-profile” (also referred to as an “alpha profile”) refers to a relative refractive index profile Δ(r) that has the following functional form:

$$Δ ( r ) = Δ ( {r}_{0} ) \{ 1 - {[ \frac{\vert r - {r}_{0} \vert}{( {r}_{1} - {r}_{0} )} ]}^{α} \}$$

where rₒ is the point at which Δ(r) is maximum, r₁ is the point at which Δ(r) is zero, and r is in the range rᵢ≤r≤r_{f}, where rᵢ is the initial point of the α-profile, r_{f} is the final point of the α-profile, and α is a real number. In some embodiments, examples shown herein can have a core alpha of 1≤α ≤100. In practice, an actual optical fiber, even when the target profile is an alpha profile, some level of deviation from the ideal configuration can occur. Therefore, the alpha parameter for an optical fiber may be obtained from a best fit of the measured index profile, as is known in the art.

The term “graded-index profile” refers to an α-profile, where α<10. The term “step-index profile” refers to an α-profile, where α≥10.

Unless otherwise noted herein, optical properties (such as dispersion, dispersion slope, etc.) are reported for the LP01 mode.

“Chromatic dispersion,” herein referred to as “dispersion” unless otherwise noted, of an optical fiber is the sum of the material dispersion, the waveguide dispersion, and the intermodal dispersion. “Material dispersion” refers to the manner in which the refractive index of the material used for the optical core affects the velocity at which different optical wavelengths propagate within the core. “Waveguide dispersion” refers to dispersion caused by the different refractive indices of the core and cladding of the optical fiber. In the case of single mode waveguide fibers, the inter-modal dispersion is zero. Dispersion values in a two-mode regime assume intermodal dispersion is zero. The zero-dispersion wavelength (λ₀) is the wavelength at which the dispersion has a value of zero. Dispersion slope is the rate of change of dispersion with respect to wavelength. Dispersion and dispersion slope are reported herein at a wavelength of 1310 nm or 1550 nm, as noted, and are expressed in units of ps/nm/km and ps/nm²/km, respectively. Chromatic dispersion is measured as specified by the IEC 60793-1-42:2013 standard, “Optical fibres—Part 1-42: Measurement methods and test procedures—Chromatic dispersion.”

The cutoff wavelength of an optical fiber is the minimum wavelength at which the optical fiber will support only one propagating mode. For wavelengths below the cutoff wavelength, multimode transmission may occur, and an additional source of dispersion may arise to limit the fiber's information carrying capacity. Cutoff wavelength will be reported herein as a cable cutoff wavelength. The cable cutoff wavelength is based on a 22-meter cabled fiber length as specified in TIA-455-80: FOTP-80 IEC-60793-1-44 Optical Fibres—Part 1-44: Measurement Methods and Test Procedures—Cut-off Wavelength (21 May 2003), by Telecommunications Industry Association (TIA).

The bend resistance of an optical fiber, expressed as “bend loss” herein, can be gauged by induced attenuation under prescribed test conditions as specified by the IEC-60793-1-47:2017 standard, “Optical fibres—Part 1-47: Measurement methods and test procedures—Macrobending loss.” For example, the test condition can entail deploying or wrapping the fiber one or more turns around a mandrel of a prescribed diameter, e.g., by wrapping 1 turn around either a 15 mm, 20 mm, or 30 mm or similar diameter mandrel (e.g. “1×15 mm diameter bend loss” or the “1×20 mm diameter bend loss” or the “1×30 mm diameter bend loss”) and measuring the increase in attenuation per turn.

The term “attenuation,” as used herein, is the loss of optical power as the signal travels along the optical fiber. Attenuation is measured as specified by the IEC 60793-1-40:2019 standard entitled “Optical fibres—Part 1-40: Attenuation measurement methods.”

As used herein, the multicore optical fiber can include a plurality of core portions, wherein each core portion can be defined as an i^{th} core portion (i.e., 1^{st}, 2^{nd}, 3^{rd}, 4^{th}, etc. . . . ). Each i^{th} core portion can have an outer radius r_{Ci}. In embodiments, the outer radius r_{Ci} of each core portion may correspond to an outer radius of an outer cladding region of that core portion. In some embodiments, the outer radius r_{Ci} of each core portion may correspond to an outer radius of a trench region of that core portion. Each i^{th} core portion is disposed within a cladding matrix of the multicore optical fiber, which defines a common cladding of the multicore optical fiber. The common cladding includes a relative refractive index Δ_{CC} and an outer radius R_{CC}.

According to one aspect of the present disclosure, the core region forms the central portion of each core portion within the multicore optical fiber and is substantially cylindrical in shape. When two regions are directly adjacent to each other, the outer radius of the inner of the two regions coincides with the inner radius of the outer of the two regions. For example, in some embodiments in which an inner cladding region surrounds and is directly adjacent to a core region, the outer radius of the core region coincides with the inner radius of the inner cladding region.

An “up-dopant” is a substance added to the glass of the component being studied that has a propensity to raise the refractive index relative to pure undoped silica. A “down-dopant” is a substance added to the glass of the component being studied that has a propensity to lower the refractive index relative to pure undoped silica. Examples of up-dopants include GeO₂ (germania), Al₂O₃, P₂O₅, TiO₂, Cl, Br, and alkali metal oxides, such as K₂O, Na₂O, Li₂O, Cs₂O, Rb₂O, and mixtures thereof. Examples of down-dopants include fluorine and boron.

As used herein, the term “substantially free,” when used to describe the concentration and/or absence of a particular up-dopant or down-dopant in a particular portion of the fiber, means that the constituent component is not intentionally added to the fiber as an “up-dopant” or a “down-dopant.” However, the fiber may contain traces of the constituent component as a contaminant or tramp in amounts. In some embodiments, the fiber may contain traces of the constituent component as a contaminant or tramp in amounts of less than or equal to 0.15 wt. %. In some embodiments, depending on the constituent component, the fiber may contain traces of the constituent component as a contaminant or tramp in amounts that may be less than or equal to 1 wt. %, less than or equal to 0.9 wt. %, less than or equal to 0.8 wt. %, less than or equal to 0.7 wt. %, less than or equal to 0.6 wt. %, less than or equal to 0.5 wt. %, less than or equal to 0.4 wt. %, less than or equal to 0.3 wt. %, less than or equal to 0.2 wt. %, less than or equal to 0.15 wt. %, less than or equal to 0.1 wt. %, less than or equal to 0.05 wt. %, or less than or equal to 0.01 wt.

The term “crosstalk” in a multi-core optical fiber is a measure of how much power leaks from one core portion to another, adjacent core portion. As used herein, the term “adjacent core portion” refers to the core that is nearest to the reference core portion. In some embodiments, all core portions may be equally spaced from one another, meaning that all core portions are adjacent one another. In other embodiments, the core portions may not be equally spaced from one another, meaning that some core portions will be spaced further from the reference core portion than adjacent core portions are spaced from the reference core portion.

As used herein, the term uncoupled-core multicore optical fiber (or uncoupled multicore optical fiber) refers to a multicore optical fiber that has crosstalk values between adjacent core portions less than or equal to −40 dB, or even less than or equal to −50 dB per 100 km of the multicore optical fiber. For example, for long-haul transmission in an uncoupled-core multicore fiber, the crosstalk should be less than or equal to −30 dB, less than or equal to −40 dB, or even less than or equal to −50 dB per 100 km.

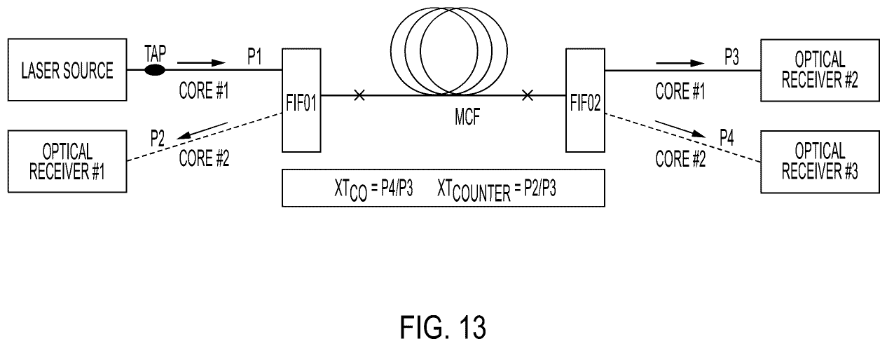

The system to measure co-propagating crosstalk and counter-propagating crosstalk, as disclosed herein, is shown in FIG. 13. In order to measure the disclosed crosstalk between adjacent core portions (e.g., as described herein, two core portions having centerlines separated by a minimum core-to-core separation distance), multicore fibers with a length between 20 km and 25 km on a standard shipping spool are tested. As shown in FIG. 13, the system comprises a tunable laser source (TLS) with a linewidth of 200 kHz, a tap to monitor the laser output power, and a multicore fiber fan-in/fan-out (FIFO 1) spliced to the fiber to inject the source light into one of two adjacent core portions of the fiber while directing backward propagating light in the other of the two adjacent core portions. A fan-out (FIFO 2) is spliced at the far end of the fiber, and its outputs are connected to optical receivers to measure forward propagating light out of each core. The optical receivers #1, #2, and #3, as shown in FIG. 13, are each a high sensitivity detector with −109 dBm noise sensitivity and linearity error with <20% deviation over the entire power measured range (+5 to −75 dBm). All three optical receivers were calibrated and read out the same power at one power level. The multicore fiber used to fabricate FIFOs had the same mode field diameter and core-to-core pitch as the transmission multicore fiber under test. Co-propagating crosstalk can then be calculated using the measured power P3 and P4, and the counter-propagating crosstalk can then be calculated using the measured P3 and P2. Further details about the measurement method and setup can be found in P. Tandon, et al., “Record Low Loss 0.144 dB/km 2-Core Optical Fiber for Submarine Transmission,” Journal of Lightwave Technology, Vol. 42, No. 12, Jun. 15, 2024, the content of which is incorporated herein by reference in its entirety.

The phrase “coupling coefficient” κ, as used herein, is related to the overlap of electric fields when the two cores are close to each other. The square of the coupling coefficient, κ², is related to the average power in core m as influenced by the power in other cores in the multicore optical fiber. The “coupling coefficient” can be estimated using the coupled power theory, with the methods disclosed in M. Koshiba, K. Saitoh, K. Takenaga, and S. Matsuo, “Analytical Expression of Average Power-Coupling Coefficients for Estimating Intercore Crosstalk in Multicore fibers,” IEEE Photonics J., 4(5), 1987-95 (2012); and T. Hayashi, T. Sasaki, E. Sasaoka, K. Saitoh, and M. Koshiba, “Physical Interpretation of Intercore Crosstalk in Multicore fiber: Effects of Macrobend, Structure Fluctuation, and Microbend,” Optics Express, 21(5), 5401-12 (2013), the contents of which are incorporated by reference herein in their entirety.

The “effective area” can be defined as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr}$$

where f(r) is the transverse component of the electric field of the guided optical signal and r is radial position in the fiber. “Effective area” or “A_{eff}” depends on the wavelength of the optical signal. Specific indication of the wavelength will be made when referring to “Effective area” or “A_{eff}” herein. Effective area is expressed herein in units of “μm²”, “square micrometers”, “square microns” or the like.

The mode field diameter (MFD) is measured using the Petermann II method and was determined from:

$$MFD = 2 w$$

$$w = \frac{{\int }_{0}^{∞} {( f ( r ) )}^{2}}{{\int }_{0}^{∞} {( \frac{df ( r )}{dr} )}^{2} rdr}$$

where f(r) is the transverse component of the electric field distribution of the guided light and r is the radial position in the fiber. Unless otherwise specified, “mode field diameter” or “MFD” refers to the mode field diameter at 1310 nm.

“Trench volume” is defined as:

$${V}_{Trench} = \vert 2 {\int }_{{r}_{Trench , inner}}^{{r}_{Trench , outer}} {Δ}_{Trench} ( r ) rdr \vert$$

where r_{Trench,inner} is the inner radius of the trench region of the refractive index profile, r_{Trench,outer} is the outer radius of the trench region of the refractive index profile, Δ_{Trench}(r) is the relative refractive index of the trench region of the refractive index profile, and r is radial position in the fiber. Trench volume is in absolute value and a positive quantity and will be expressed herein in units of %Δmicron², %Δ-micron², %Δ-μm², or %Δμm², whereby these units can be used interchangeably herein. A trench region is also referred to herein as a depressed-index cladding region.

Directional terms as used herein—for example up, down, right, left, front, back, top, bottom—are made only with reference to the figures as drawn and are not intended to imply absolute orientation.

While the techniques and/or procedures are depicted and/or described in a certain order for purpose of illustration, it should be appreciated that certain techniques and/or procedures may be re-ordered and/or omitted within the scope of various embodiments.

Regardless of whether shown or described in combination or separately, the various features (both structural and methodological) are intended to be selectively rearranged, included, or omitted to produce an example or embodiment with a particular set of features.

As used herein, the singular forms “a,” “an” and “the” include plural referents unless the context clearly dictates otherwise. Thus, for example, reference to “a” component includes aspects having two or more such components, unless the context clearly indicates otherwise.

A great variety of multicore optical fibers for space division multiplexing (SDM) have been demonstrated. As the industry focus shifts to product realization, practical factors, such as mechanical properties, bending loss, simplicity of operation, minimum change in infrastructure, etc., all become increasingly important.

The inventors have developed multicore optical fibers with form factors, including but not limited to coating diameter, that are similar to or the same as those of existing fibers, such as submarine fibers. The multicore optical fiber disclosed herein can be processed in existing cable designs. The multicore optical fibers described herein may be incorporated into transmission systems for C band and/or L band transmission in bidirectional mode. Further, the multicore optical fiber disclosed herein may be uncoupled in that the crosstalk values at 1550 nm between adjacent core portions may be less than or equal to −30 dB, less than or equal to −40 dB, or less than or equal to −50 dB per 100 km of the multicore optical fiber for bidirectional transmission.

In some embodiments, the uncoupled multicore optical fiber described herein for bidirectional transmission may include greater than or equal to 6 core portions. An outer diameter of the common cladding of the multicore optical fiber may be greater than or equal to 140 microns and less than or equal to 180 microns. A coating diameter of the multicore optical fiber may be greater than or equal to 240 microns and less than or equal to 255 microns.

In some embodiments, the multicore optical fiber may include trench assisted designs as will be discussed in more detail below. The core portions may each have an effective area greater than or equal to 75 micron² and less than or equal to 135 micron². An attenuation of each core portion of the multicore optical fiber at a wavelength of 1550 nm may be less than or equal to less than 0.165 dB/km. A radiation loss of each core portion of the multicore optical fiber may be less than or equal to 0.01 dB/km at a wavelength of 1550 nm. A cable cutoff wavelength of the multicore optical fiber may be less than or equal to 1530 nm. The multicore optical fiber may include a core multiplicity factor greater than or equal to 0.028 and less than or equal to 0.045. A counter-propagating crosstalk at 1550 nm between two adjacent core portions may be less than or equal to −40 dB per 100 km of the multicore optical fiber.

The multicore optical fiber designs described herein represent a higher fiber capacity compared to existing fiber designs. In some embodiments, the multicore optical fibers described herein may demonstrate 3 to 8 times capacity increase compared to a single core optical fiber. Furthermore, despite the increase in capacity, the form factors of the multicore optical fibers described herein are similar to those of existing submarine fibers and can be readily processed in existing cable designs.

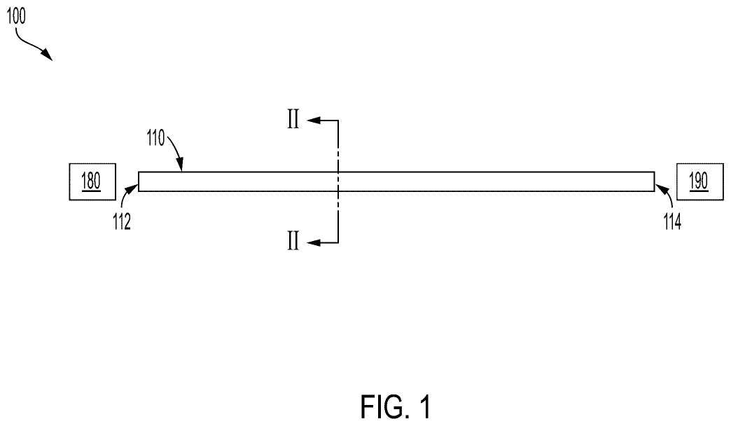

FIG. 1 depicts a simplified schematic diagram of an exemplary optical system 100 for bidirectional (or counterpropagating) transmission over an uncoupled-core multicore optical fiber 110 (or multicore optical fiber 110) having a plurality of core portions. In some embodiments, the optical system 100 may include a first transceiver 180 and a second transceiver 190 optically coupled by the multicore optical fiber 110. The multicore optical fiber 110 may include a first end 112 optically coupled to the first transceiver 180 and a second end 114 optically coupled to the second transceiver 190. The multicore optical fiber 110 may be configured for transmission at one or more wavelengths in C band and/or L band, such as one or more wavelengths between 1535 nm and 1625 nm.

In some embodiments, the first transceiver 180 may include a first plurality of light sources configured to produce optical signals for transmitting over the multicore optical fiber 110. The optical signals from the first plurality of light sources of the first transceiver 180 may be transmitted from the first end 112 of the multicore optical fiber 110 to the second end 114 of the multicore optical fiber 110 via a first plurality of core portions of the multicore optical fiber 110. In some embodiments, the first transceiver 180 and the first end 112 of the multicore optical fiber 110 may be optically coupled such that each of the first plurality of light sources of the first transceiver 180 may transmit photons into an individual core portion of the first plurality of the core portions of the multicore optical fiber 110.

In some embodiments, the second transceiver 190 may include a second plurality of light sources configured to produce optical signals for transmitting over the multicore optical fiber 110. The optical signals from the second plurality of light sources of the second transceiver 190 may be transmitted from the second end 114 of the multicore optical fiber 110 to the first end 112 of the multicore optical fiber 110 via a second plurality of core portions of the multicore optical fiber 110. The second plurality of core portions of the multicore optical fiber 110 may be different from the first plurality of core portions of the multicore optical fiber 110. In some embodiments, the second transceiver 190 and the second end 114 of the multicore optical fiber 110 may be optically coupled such that each of the second plurality of light sources of the second transceiver 190 may transmit photons into an individual core portion of the second plurality of the core portions of the multicore optical fiber 110.

Depending on applications, the first transceiver 180 and/or the second transceiver 190 may be configured such that transmission of optical signals from any one light source of the first and/or second plurality of light sources to a corresponding core portion of the multicore optical fiber 110 may be independent from, or dependent upon, transmission of optical signals from any other light source(s) of the first and/or plurality of light sources to corresponding core portion(s) of the multicore optical fiber 110. Transmission of optical signals from any one light source of the first and/or second plurality of light sources to a corresponding core portion of the multicore optical fiber 110 may be performed simultaneously with transmission of optical signals from any other light source(s) of the first and/or second plurality of light sources to corresponding core portion(s) of the multicore optical fiber 110.

In some embodiments, the first transceiver 180 may further include a first plurality of detectors, such as photodetectors, configured to detect optical signals from the multicore optical fiber 110. For example, the first plurality of detectors may be configured to receive optical signals transmitted from the second transceiver 190 from the second end 114 of the multicore optical fiber 110 to the first end 112 of the multicore optical fiber 110 via the second plurality of core portions of the multicore optical fiber 110. In some embodiments, the first transceiver 180 and the first end 112 of the multicore optical fiber 110 may be optically coupled such that each of the first plurality of detectors of the first transceiver 180 may receive optical signals from an individual core portion of the second plurality of core portions of the multicore optical fiber 110.

In some embodiments, the second transceiver 190 may further include a second plurality of detectors, such as photodetectors, configured to detect optical signals from the multicore optical fiber 110. For example, the second plurality of detectors may be configured to receive optical signals transmitted from the first transceiver 180 from the first end 112 of the multicore optical fiber 110 to the second end 114 of the multicore optical fiber 110 via the first plurality of core portions of the multicore optical fiber 110. In some embodiments, the second transceiver 190 and the second end 114 of the multicore optical fiber 110 may be optically coupled such that each of the second plurality of detectors of the second transceiver 190 may receive optical signals from an individual core portion of the first plurality of core portions of the multicore optical fiber 110.

As mentioned above, the multicore optical fiber 110 may be configured for transmission at one or more wavelengths in C band and/or L band to further increase transmission capacity. C band refers to the wavelength range from 1535 nm to 1565 nm, and L band refers to the wavelength range from 1565 nm to 1625 nm. In some embodiments, one or more of the first plurality of core portions and/or one or more of the second plurality of core portions may be configured for transmission over at least one of C band or L band. In some embodiments, each of the first plurality of core portions and/or each of the second plurality of core portions may be configured for transmission over at least one of C band or L band. In some embodiments, each of the first plurality of core portions and/or each of the second plurality of core portions may be configured for transmission over both C band and L band (or C+L band). In some embodiments, the transmission over C band and L band may be performed simultaneously. In some embodiments, the transmission over C band and L band may be performed simultaneously over a common core portion.

More specifically, in some embodiments, optical signals may be transmitted at one or more wavelengths of C band via one or more core portions of the first plurality of core portions in a first direction from the first transceiver 180 to the second transceiver 190. Optical signals may also be transmitted at one or more wavelengths of L band via one or more core portions of the first plurality of core portions in the first direction. In some embodiments, the multicore optical fiber 110 described herein may allow the transmission of signals in the first direction over C band and L band to be performed over a common core portion of the first plurality of core portions, and in some embodiments, the transmission of signals in the first direction over C band and L band may be performed over the common core portion simultaneously.

Similarly, in some embodiments, optical signals may be transmitted at one or more wavelengths of C band via one or more core portions of the second plurality of core portions in a second direction from the second transceiver 190 to the first transceiver 180. Optical signals may also be transmitted at one or more wavelengths of L band via one or more core portions of the second plurality of core portions in the second direction. In some embodiments, the transmission of signals in the second direction over C band and L band may be performed over a common core portion of the second plurality of core portions, and in some embodiments, the transmission of signals in the second direction over C band and L band may be performed over the common core portion simultaneously.

Although transmission over C band and L band over the same core portion in the same direction is described an example, in some embodiments, the transmission over C band and L band may be conducted over the same core portion in opposite directions. In some embodiments, the transmission over C band and L band may be conducted over different core portions in the same direction. In some embodiments, the transmission over C band and L band may be conducted over different core portions in different directions.

Further, although bidirectional (or counterpropagating) transmission is described herein as an example utilizing the multicore optical fiber 110, in some embodiments, the multicore optical fiber 110 may also be utilized for unidirectional transmission where the first plurality of core portions and the second plurality of core portions may be configured to transmit optical signals in the same direction. For example, in some embodiments, one or more of the first plurality of core portions and one or more of the second plurality of core portions may be configured to transmit over different wavelengths of C band and/or L band to minimize crosstalk for unidirectional (or copropagating) transmission.

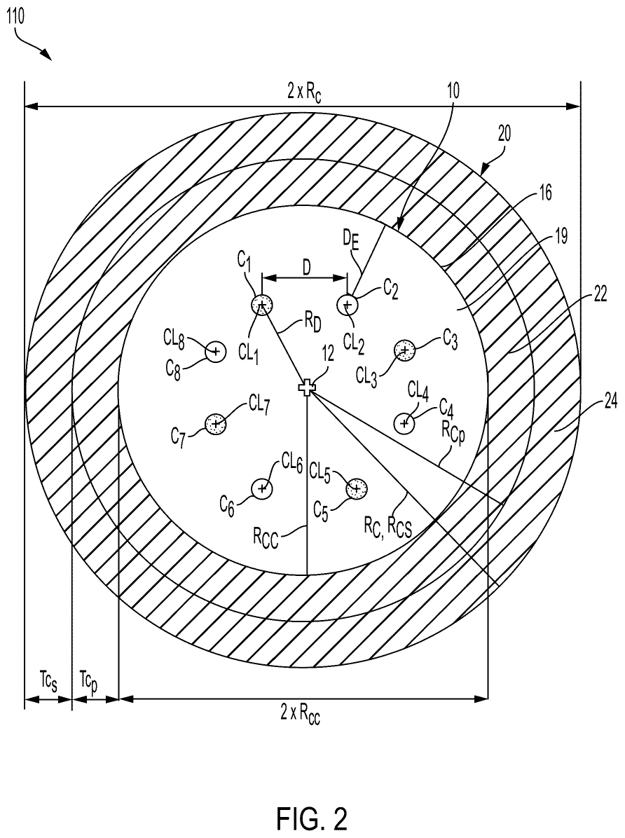

FIG. 2 schematically illustrates a radial cross section of an exemplary embodiment of the multicore optical fiber 110 viewed along line II-II of FIG. 1. In some embodiments, the multicore optical fiber 110 may include a glass fiber portion 10 and a non-glass, polymer coating portion 20. In some embodiments, the coating portion 20 may include a primary coating layer and a secondary coating layer as will be discussed in more detail below. The multicore optical fiber 110 may include a central fiber axis 12, which defines radial position R=0. In some embodiments, the central fiber axis 12 of the multicore optical fiber 110 may correspond to the centerline of the glass fiber portion 10 and/or the non-glass coating portion 20.

In some embodiments, the glass fiber portion 10 may include a common cladding 19 and a plurality of core portions Cᵢ (described in more detail below) disposed within the common cladding 19. The common cladding 19 may include an outer radius R_{CC}. In some embodiments, the outer radius R_{CC} of the common cladding 19 may be greater than or equal to 70 μm, greater than or equal to 75 μm, greater than or equal to 80 μm, greater than or equal to 85 μm, or greater than or equal to 90 μm. In some embodiments, the outer radius R_{CC} of the common cladding 19 may be less than or equal to 95 μm, less than or equal to 90 μm, less than or equal to 85 μm, less than or equal to 80 μm, less than or equal to 75 μm. In some embodiments, the outer radius R_{CC} of the common cladding 19 may be greater than or equal to 70 μm and less than or equal to 95 μm—including all sub-ranges and values there-between. For example, in some embodiments, the outer radius R_{CC} of the common cladding 19 may be greater than or equal to 70 μm and less than or equal to 90 μm, greater than or equal to 70 μm and less than or equal to 85 μm, greater than or equal to 75 μm and less than or equal to 95 μm, greater than or equal to 75 μm and less than or equal to 90 μm, or greater than or equal to 75 μm and less than or equal to 85 μm.

In some embodiments, such as in the embodiment depicted in FIG. 2, the outer radius R_{CC} of the common cladding 19 may correspond to the outer radius of the glass fiber portion 10. A glass diameter of the glass fiber portion 10 (2×R_{CC}) may be greater than or equal to 140 μm and less than or equal to 190 μm—including all sub-ranges and values there-between. For example, in some embodiments, the glass diameter of the glass fiber portion 10 (2×R_{CC}) may be greater than or equal to 150 μm and less than or equal to 190 μm, greater than or equal to 160 μm and less than or equal to 190 μm, greater than or equal to 170 μm and less than or equal to 190 μm, greater than or equal to 180 μm and less than or equal to 190 μm, greater than or equal to 140 μm and less than or equal to 180 μm, greater than or equal to 150 μm and less than or equal to 180 μm, greater than or equal to 160 μm and less than or equal to 180 μm, greater than or equal to 170 μm and less than or equal to 180 μm, greater than or equal to 140 μm and less than or equal to 170 μm, greater than or equal to 150 μm and less than or equal to 170 μm, greater than or equal to 160 μm and less than or equal to 170 μm, greater than or equal to 140 μm and less than or equal to 160 μm, greater than or equal to 150 μm and less than or equal to 160 μm, or greater than or equal to 140 μm and less than or equal to 150 μm.

In some embodiments, the common cladding 19 may include a relative refractive index Δ_{CC}. The relative refractive index Δ_{CC} of the common cladding 19 may be in a range from about −0.2%Δ to about −0.4%Δ—including all sub-ranges and values there-between. For example, in some embodiments, the relative refractive index Δ_{CC} of the common cladding 19 may be in a range from about −0.2%Δ to about −0.38%Δ, from about −0.2%Δ to about −0.35%Δ, from about −0.2%Δ to about −0.32%Δ, from about −0.2%Δ to about −0.3%Δ, from about −0.2%Δ to about −0.28%Δ, from about −0.2%Δ to about −0.25%Δ, from about −0.2%Δ to about −0.22%Δ, from about −0.22%Δ to about −0.4%Δ, from about −0.22%Δ to about −0.38%Δ, from about −0.22%Δ to about −0.35%Δ, from about −0.22%Δ to about −0.32%Δ, from about −0.22%Δ to about −0.3%Δ, from about −0.22%Δ to about −0.28%Δ, from about −0.22%Δ to about −0.25%Δ, from about −0.25%Δ to about −0.4%Δ, from about −0.25%Δ to about −0.38%Δ, from about −0.25%Δ to about −0.35%Δ, from about −0.25%Δ to about −0.32%Δ, from about −0.25%Δ to about −0.3%Δ, from about −0.25%Δ to about −0.28%Δ, from about −0.28%Δ to about −0.4%Δ, from about −0.28%Δ to about −0.38%Δ, from about −0.28%Δ to about −0.35%Δ, from about −0.28%Δ to about −0.32%Δ, from about −0.28%Δ to about −0.3%Δ, from about −0.3%Δ to about −0.4%Δ, from about −0.3%Δ to about −0.38%Δ, from about −0.3%Δ to about −0.35%Δ, from about −0.3%Δ to about −0.32%Δ, from about −0.32%Δ to about −0.4%Δ, or from about −0.32%Δ to about −0.38%Δ, from about −0.32%Δ to about −0.35%Δ, from about −0.35%Δ to about −0.4%Δ, or from about −0.35%Δ to about −0.38%Δ, or from about −0.38%Δ to about −0.4%Δ. In some embodiments, the relative refractive index Δ_{CC} may be preferably constant or approximately constant within the common cladding 19.

In some embodiments, the coating portion 20 may encircle and directly contact the common cladding 19 and may extend from the outer radius R_{CC} of the common cladding 19 to an outer radius R_{C} of the coating portion 20. In some embodiments, the outer radius R_{C} of the coating portion 20 may be greater than or equal to 120 μm, greater than or equal to 122 μm, greater than or equal to 124 μm, or greater than or equal to 125 μm. In some embodiments, the outer radius R_{C} of the coating portion 20 may be less than or equal to 127.5 μm, less than or equal to 127 μm, less than or equal to 126 μm, or less than or equal to 125 μm. In some embodiments, the outer radius R_{C} of the coating portion 20 may be greater than or equal to 120 μm and less than or equal to 127.5 μm—including all sub-ranges and values there-between. For example, in some embodiments, the outer radius R_{C} of the coating portion 20 may be greater than or equal to 122.5 μm and less than or equal to 127.5 μm, greater than or equal to 124 μm and less than or equal to 126 μm, or in some embodiments, the outer radius R_{C} of the coating portion 20 may be about 125 μm. In some embodiments, the multicore optical fiber 110 may include form factors, such as coating diameter (2×R_{C}), that may be similar to or the same as those of existing submarine fibers. Thus, the multicore optical fiber 110 described herein can be readily processed in existing cable designs while providing improved performance (as discussed below) than the existing submarine fibers.

In some embodiments, the coating portion 20 may include a primary coating 22 and a secondary coating 24. In some embodiments, the primary coating 22 may encircle and directly contact the common cladding 19 and may extend from the outer radius R_{CC} of the common cladding 19 to an outer radius R_{Cp} of the primary coating 22. In some embodiments, the outer radius R_{Cp} of the primary coating 22 may be greater than or equal to 170 μm, greater than or equal to 185 μm, greater than or equal to 200 μm, or greater than or equal to 215 μm. In some embodiments, the outer radius R_{Cp} of the primary coating 22 may be less than or equal to 220 μm, less than or equal to 205 μm, less than or equal to 190 μm, less than or equal to 175 μm. In some embodiments, the outer radius R_{Cp} of the primary coating 22 may be greater than or equal to 170 μm and less than or equal to 220 μm—including all sub-ranges or values therebetween. For example, in some embodiments, the outer radius R_{Cp} of the primary coating 22 may be greater than or equal to 170 μm and less than or equal to 210 μm, greater than or equal to 170 μm and less than or equal to 200 μm, greater than or equal to 170 μm and less than or equal to 185 μm, greater than or equal to 180 μm and less than or equal to 220 μm, greater than or equal to 180 μm and less than or equal to 210 μm, greater than or equal to 180 μm and less than or equal to 200 μm, greater than or equal to 190 μm and less than or equal to 220 μm, greater than or equal to 190 μm and less than or equal to 210 μm, greater than or equal to 190 μm and less than or equal to 200 μm, or greater than or equal to 210 μm and less than or equal to 220 μm.

In some embodiments, a thickness T_{Cp} of the primary coating 22, as defined by a difference between the outer radius R_{Cp} of the primary coating 22 and the outer radius R_{CC} of the common cladding 19 (i.e., T_{Cp}=R_{Cp}−R_{CC}), may be greater than or equal to 14 μm, greater than or equal to 17 μm, greater than or equal to 20 μm, greater than or equal to 23 μm, greater than or equal to 27 μm, greater than or equal to 30 μm, or greater than or equal to 33 μm. In some embodiments, the thickness T_{Cp} of the primary coating 22 may be less than or equal to 35 μm, less than or equal to 32 μm, less than or equal to 29 μm, less than or equal to 26 μm, less than or equal to 22 μm, less than or equal to 19 μm, or less than or equal to 16 μm. In some embodiments, the thickness T_{Cp} of the primary coating 22 may be greater than or equal to 14 μm and less than or equal to 35 μm—including all sub-ranges and values there-between. For example, in some embodiments, the thickness T_{Cp} of the primary coating 22 may be greater than or equal to 18 μm and less than or equal to 30 μm, or greater than or equal to 22 μm and less than or equal to 26 μm.

In some embodiments, the secondary coating 24 may encircle and directly contact the primary coating 22 and may extend from the outer radius R_{Cp} of the primary coating 22 to an outer radius R_{Cs} of the secondary coating 24. In some embodiments, such as in the embodiment depicted in FIG. 2, the outer radius R_{Cs} of the secondary coating 24 may correspond to the outer radius R_{C} of the coating portion 20.

In some embodiments, the outer radius R_{Cs} of the secondary coating 24 may be greater than or equal to 120 μm, greater than or equal to 122 μm, greater than or equal to 124 μm, or greater than or equal to 125 μm. In some embodiments, the outer radius R_{Cs} of the secondary coating 24 may be less than or equal to 127.5 μm, less than or equal to 127 μm, less than or equal to 126 μm, or less than or equal to 125 μm. In some embodiments, the outer radius R_{Cs} of the secondary coating 24 may be greater than or equal to 120 μm and less than or equal to 127.5 μm—including all sub-ranges and values there-between. For example, in some embodiments, the outer radius R_{Cs} of the secondary coating 24 may be greater than or equal to 122.5 μm and less than or equal to 127.5 μm, greater than or equal to 124 μm and less than or equal to 126 μm, or in some embodiments, the outer radius R_{Cs} of the secondary coating 24 may be about 125 μm.

In some embodiments, a thickness T_{Cs} of the secondary coating 24, as defined by a difference between the outer radius R_{Cs} of the secondary coating 24 and the outer radius R_{Cp} of the primary coating 22 (i.e., T_{Cs}=R_{Cs}−R_{Cp}), may be greater than or equal to 14 μm, greater than or equal to 17 μm, greater than or equal to 20 μm, greater than or equal to 23 μm, greater than or equal to 27 μm, greater than or equal to 30 μm, or greater than or equal to 33 μm. In some embodiments, the thickness T_{Cs} of the secondary coating 24 may be less than or equal to 35 μm, less than or equal to 32 μm, less than or equal to 29 μm, less than or equal to 26 μm, less than or equal to 22 μm, less than or equal to 19 μm, or less than or equal to 16 μm. In some embodiments, the thickness T_{Cs} of the secondary coating 24 may be greater than or equal to 14 μm and less than or equal to 35 μm—including all sub-ranges and values there-between. For example, in some embodiments, the thickness T_{Cs} of the secondary coating 24 may be greater than or equal to 18 μm and less than or equal to 30 μm, or greater than or equal to 22 μm and less than or equal to 26 μm.

In some embodiments, a ratio of the thickness T_{Cs} of the secondary coating 24 to the thickness T_{Cp} of the primary coating 22 may be greater than or equal to 0.7, greater than or equal to 0.8, greater than or equal to 0.9, greater than or equal to 1.0, greater than or equal to 1.1, or greater than or equal to 1.2. In some embodiments, the ratio of the thickness T_{Cs} of the secondary coating 24 to the thickness T_{Cp} of the primary coating 22, may be less than or equal to 1.3, less than or equal to 1.2, less than or equal to 1.1, less than or equal to 1.0, less than or equal to 0.9, or less than or equal to 0.8. In some embodiments, the ratio of the thickness of the secondary coating 24 to the thickness T_{Cp} of the primary coating 22 may be greater than or equal to 0.7 and less than or equal to 1.3—including all sub-ranges and values there-between. For example, in some embodiments, the ratio of the thickness T_{Cs} of the secondary coating 24 to the thickness T_{Cp} of the primary coating 22 may be greater than or equal to 0.8 and less than or equal to about 1.3, greater than or equal to 0.9 and less than or equal to 1.2, greater than or equal to 0.9 and less than or equal to 1.1, greater than or equal to 0.8 and less than or equal to 1.0, greater than or equal to 1.0 and less than or equal to 1.2, or greater than or equal to 1.0 and less than or equal to 1.1. The inventors have recognized that the thickness ratio of the secondary coating 24 to the primary coating 22 described herein may allow for reduction in microbending loss of the optical fiber when deployed in an optical fiber cable.

In some embodiments, an in-situ modulus of the primary coating 22 may be less than an in-situ modulus of the secondary coating 24. In some embodiments, the in-situ modulus of the primary coating 22 may be greater than or equal to 0.15 MPa, greater than or equal to 0.21 MPa, greater than or equal to 0.27 MPa, greater than or equal to 0.33 MPa, or greater than or equal to 0.39 MPa. In some embodiments, the in-situ modulus of the primary coating 22 may be less than or equal to 0.4 MPa, less than or equal to 0.34 MPa, less than or equal to 0.28 MPa, less than or equal to 0.22 MPa, or less than or equal to 0.16 MPa. In some embodiments, the in-situ modulus of the primary coating 22 may be greater than or equal to 0.15 MPa and less than or equal to 0.4 MPa—including all sub-ranges and values there-between. For example, in some embodiments, the in-situ modulus of the primary coating 22 may be greater than or equal to 0.2 MPa and less than or equal to 0.35 MPa, greater than or equal to 0.25 MPa and less than or equal to 0.35 MPa, greater than or equal to 0.2 MPa and less than or equal to 0.3 MPa, or greater than or equal to 0.25 MPa and less than or equal to 0.3 MPa.

In some embodiments, the in-situ modulus of the secondary coating 24 may be greater than or equal to 1,600 MPa, greater than or equal to 1,800 MPa, greater than or equal to 2,000 MPa, greater than or equal to 2,200 MPa, or greater than or equal to 2,300 MPa. In some embodiments, the in-situ modulus of the secondary coating 24 may be less than or equal to 2,400 MPa, less than or equal to 2,200 MPa, less than or equal to 2,000 MPa, less than or equal to 1,800 MPa, or less than or equal to 1,700 MPa. In some embodiments, the in-situ modulus of the secondary coating 24 may be greater than or equal to 1,600 MPa and less than or equal to 2,400 MPa—including all sub-ranges and values there-between. For example, in some embodiments, the in-situ modulus of the secondary coating 24 may be greater than or equal to 1,750 MPa and less than or equal to 2,250 MPa, greater than or equal to 1,750 MPa and less than or equal to 2,100 MPa, greater than or equal to 1,900 MPa and less than or equal to 2,250 MPa, or greater than or equal to 1,900 MPa and less than or equal to 2,100 MPa.

With further reference to FIG. 2, the multicore optical fiber 110 may include a plurality of core portions C that may be uncoupled. The core portions C may be individually denoted Cᵢ, such as individually denoted C₁, C₂, C₃, C₄, C₅, C₆, C₇, and C₈ in the exemplary embodiment shown in FIG. 2, and collectively referred to as core portions C. Each core portion C₁ may generally extend through a length of the multicore optical fiber 110 parallel to the central fiber axis 12. Although 8 core portions are shown in the exemplary embodiment in FIG. 2, the multicore optical fiber 110 may include more or less than 8 core portions that are uncoupled. In some embodiments, the multicore optical fiber 110 may include greater than or equal to 6 core portions, greater than or equal to 7 core portions, greater than or equal to 8 core portions, greater than or equal to 9 core portions, or greater than or equal to 10 core portions. In some embodiments, the multicore optical fiber 110 may include less than or equal to 10 core portions, less than or equal to 9 core portions, less than or equal to 8 core portions, less than or equal to 7 core portions, less than or equal to 6 core portions. In some embodiments, the multicore optical fiber 110 may include 6 to 10—including all sub-ranges and values there-between—core portions. For example, in some embodiments, the multicore optical fiber 110 may include 6 to 10 core portions, 6 to 8 core portions, 8 to 10 core portions, or in some embodiments, the multicore optical fiber 110 may include 6 core portions, 8 core portions, or 10 core portions.

Each core portion Cᵢ may include a central axis or centerline CLᵢ (which defines radial position r=0 for each core portion) and an outer radius r_{Ci}. A position of each CLᵢ within the multicore optical fiber 110 can be defined using Cartesian coordinates with the central fiber axis 12 defining the origin (0,0) of an x-y coordinate system coincident with the coordinate system defined by the radial coordinate R. The position of centerline CLᵢ can be defined as (xᵢ,yᵢ) (e.g., the position of centerline CL₁ being defined as (x₁,y₁), the position of centerline CL₂ being defined as (x₂,y₂), etc.).

In some embodiments, each of the core portions Cᵢ may be separated from a nearest core portion (e.g., the core portion Cᵢ having a central axis CLᵢ that is closest to the central axis of that core portion) by a minimum core-to-core separation distance (or “minimum separation distance”). Core portions having central axes that are most proximate to one another (i.e., there is no other core portion having a central axis that is more proximate to a core portion than an adjacent core portion) may be referred to as adjacent core portions. The minimum separation distance thus may refer to the separation distance between a core portion and its adjacent (or nearest) core portion. The minimum separation distance between two adjacent core portions Cₘ and Cₙ may be defined as the following:

$${D}_{( {C}_{m} , {C}_{n} )} = \sqrt{{( {x}_{m} - {x}_{n} )}^{2} + {( {y}_{m} - {y}_{n} )}^{2}}$$

where (xₘ, yₘ) denotes the positional coordinates of the central axis CLₘ of core portion Cₘ, and (xₙ, yₙ) denotes the positional coordinates of the central axis CLₙ of core portion C₁.

In some embodiments, a core portion Cᵢ may be separated from more than one core portion by the minimum separation distance. As a non-limiting example, in the exemplary embodiment as depicted in FIG. 2, the core portions C₁, C₂, C₃, C₄, C₅, C₆, C₇, and C₈ may be arranged annularly and form a ring about the central fiber axis 12. Thus, in some embodiments, the core portions C₁, C₂, C₃, C₄, C₅, C₆, C₇, and C₈ may be arranged along the circumference of a circle that has its center located at the central fiber axis 12 (or radial position R=0) and a radius (or circumradius) R_{D} defined by the distance between the central fiber axis 12 and the respective center lines CL₁, CL₂, CL₃, CL₄, CL₅, CL₆, CL₇, and CL₈ of the core portions C₁, C₂, C₃, C₄, C₅, C₆, C₇, and C₈. Accordingly, the core portions C₁, C₂, C₃, C₄, C₅, C₆, C₇, and C₈ are positioned at an equal radial distance R_{D} from the central fiber axis 12.

In some embodiments, the radius (or circumradius) R_{D} may be greater than or equal to 30 μm, greater than or equal to 35 μm, greater than or equal to 40 μm, or greater than or equal to 45 μm. In some embodiments, the radius (or circumradius) R_{D} may be less than or equal to 50 μm, less than or equal to 45 μm, less than or equal to 40 μm, or less than or equal to 35 μm. In some embodiments, the radius (or circumradius) R_{D} may range from about 30 μm to about 50 μm—including all sub-ranges and values there-between. For example, in some embodiments, the radius (or circumradius) R_{D} may be greater than or equal to 30 μm and less than or equal to 50 μm, greater than or equal to 35 μm and less than or equal to 50 μm, greater than or equal to 40 μm and less than or equal to 50 μm, greater than or equal to 45 μm and less than or equal to 50 μm, greater than or equal to 30 μm and less than or equal to 45 μm, greater than or equal to 35 μm and less than or equal to 45 μm, greater than or equal to 40 μm and less than or equal to 45 μm, greater than or equal to 30 μm and less than or equal to 40 μm, greater than or equal to 35 μm and less than or equal to 40 μm, or greater than or equal to 30 μm and less than or equal to 35 μm.

Further, in the exemplary embodiment as depicted in FIG. 2, the center lines CL₁, CL₂, CL₃, CL₄, CL₅, CL₆, CL₇, and CL₈ of the core portions C₁, C₂, C₃, C₄, C₅, C₆, C₇, and C₈ are equally spaced apart along the circumference of the circle. Thus, in this exemplary arrangement, each of the core portions C₁, C₂, C₃, C₄, C₅, C₆, C₇, and C₈ is separated from two adjacent core portions by the minimum separation distance.

In some embodiments, the minimum separation distance between two adjacent core portions may be greater than or equal to 32 μm, greater than or equal to 33 μm, greater than or equal to 34 μm, greater than or equal to 35 μm, greater than or equal to 36 μm, greater than or equal to 37 μm, greater than or equal to 38 μm, greater than or equal to 39 μm, or greater than or equal to 40. In some embodiments, the minimum separation distance between two adjacent core portions may be less than or equal to 50 μm, less than or equal to 46 μm, less than or equal to 42 μm, less than or equal to 40 μm, less than or equal to 38 μm, less than or equal to 36 μm, less than or equal to 34 μm, or less than or equal to 33 μm.

In some embodiments, the minimum separation distance between two adjacent core portions may be greater than or equal to 32 μm and less than or equal to 50 μm—including all sub-ranges and values there-between. For example, in some embodiments, the minimum separation distance between two adjacent core portions may be greater than or equal to 32 μm and less than or equal to 45 μm, greater than or equal to 32 μm and less than or equal to 42 μm, greater than or equal to 32 μm and less than or equal to 38 μm, greater than or equal to 32 μm and less than or equal to 36 μm, greater than or equal to 33 μm and less than or equal to 50 μm, greater than or equal to 33 μm and less than or equal to 45 μm, greater than or equal to 33 μm and less than or equal to 40 μm, greater than or equal to 33 μm and less than or equal to 36 μm, greater than or equal to 34 μm and less than or equal to 50 μm, greater than or equal to 34 μm and less than or equal to 45 μm, greater than or equal to 34 μm and less than or equal to 42 μm, greater than or equal to 34 μm and less than or equal to 40 μm, greater than or equal to 34 μm and less than or equal to 36 μm, greater than or equal to 36 μm and less than or equal to 50 μm, greater than or equal to 36 μm and less than or equal to 45 μm, greater than or equal to 36 μm and less than or equal to 42 μm, greater than or equal to 36 μm and less than or equal to 40 μm, greater than or equal to 40 μm and less than or equal to 50 μm, or greater than or equal to 40 μm and less than or equal to 45 μm.

In some embodiments, edges of the plurality of core portions Cᵢ may also be spaced apart from an outer surface 16 of the glass fiber portion 10 of the multicore optical fiber 110 by at least a minimum core edge to glass fiber edge distance D_{E} as measured from the edge of each of the core portions to the outer surface 16 of the glass fiber portion 10. As depicted in FIG. 2, the minimum core edge to glass fiber edge distance D_{E} is the minimum distance from a point along the outer circumference of a core portion Cᵢ(e.g., a point on the outer circumference that is closest to the outer surface 16) to a nearest point along the circumference of the outer surface 16 of the glass fiber portion 10, as determined by a line segment between the point along the outer circumference of the core portion Cᵢ and the nearest point along the circumference on the outer surface 16 in a plan perpendicular to the fiber axis 12. The outer circumference of each core portion Cᵢ may be defined by the outer radius R_{Ci} of each core portion Cᵢ which may correspond to an outer radius of a trench region of each core portion Cᵢ as will be discussed in more detail below.

Without intending to be bound by any particular theory, it is believed that the extent of signal loss due to tunneling, such as radiation loss of each core portion Cᵢ, may be influenced by the minimum value for D_{E}. In some embodiments, the minimum core edge to glass fiber edge distance D_{E} may be greater than or equal to 10 μm, greater than or equal to 15 μm, greater than or equal to 20 μm, or greater than or equal to 25 μm. In some embodiments, D_{E} may be less than or equal to 40 μm, less than or equal to 35 μm, less than or equal to 25 μm, less than or equal to 20 μm. In some embodiments, D_{E} may range be in a range from about 10 μm to about 30 μm—including all sub-ranges and values there-between. For example, in some embodiments, D_{E} may be in a range from about 10 μm to about 25 μm, from about 10 μm to about 20 μm, from about 10 μm to about 15 μm, from about 15 μm to about 40 μm, from about 15 μm to about 35 μm, from about 15 μm to about 25 μm, from about 20 μm to about 30 μm, from about 20 μm to about 25 μm, or from about 25 μm to about 40 μm.

The minimum core edge to glass fiber edge distance D_{E} may also influence the crosstalk between adjacent core portions of the multicore optical fiber 110. Specifically, as the values for the minimum core edge to glass fiber edge distance D_{E} increase, core-to-core separation distance D may be reduced, which may lead to increased crosstalk between adjacent core portions. To minimize radiation leakage loss while also limiting crosstalk between adjacent core portions, the inventors have discovered that a core multiplicity factor (CMF) in the range from about 0.028 to about 0.045 may be selected to yield superior performance that achieve both low radiation loss and low crosstalk between adjacent core portions of the multicore optical fiber 110 as described herein.

The “core multiplicity factor” (CMF) of the multicore optical fiber can be determined in accordance with the following equation:

$$CMF = \frac{{\sum }_{i = 1}^{m} {A}_{{eff}_{i}}}{π {{R}_{CC}}^{2}}$$

wherein m is the number of core portions C with the multicore optical fiber 110, A_{eff}_{ᵢ} is the effective area of each core portion Cᵢ, and R_{CC} is the outer radius of the common cladding 19 of the multicore optical fiber 110 which also corresponds to the outer radius of the glass fiber portion 10 of the multicore optical fiber 110. In some embodiments, the effective areas A_{eff}_{ᵢ} of the core portions C are substantially the same, the core multiplicity factor of the multicore optical fiber 110 can be determined in accordance with the following equation:

$$CMF = \frac{m \times {A}_{eff}}{π {{R}_{CC}}^{2}}$$

In some embodiments, the designs of the multicore optical fiber 110 described herein may provide a CMF greater than or equal to 0.028 that may achieve both low radiation loss and low crosstalk. For example, in some embodiments, the CMF of the multicore optical fiber 110 may be greater than or equal to 0.03, greater than or equal to 0.033, greater than or equal to 0.035, greater than or equal to 0.037, greater than or equal to 0.04, or greater than or equal to 0.043. In some embodiments, the CMF of the multicore optical fiber 110 may be less than or equal to 0.045, less than or equal to 0.043, less than or equal to 0.04, less than or equal to 0.037, less than or equal to 0.035, less than or equal to 0.033, less than or equal to 0.032, or less than or equal to 0.03.

In some embodiments, the multicore optical fiber 110 described herein may provide a CMF ranging from about 0.028 to about 0.045—including all sub-ranges and values there-between. For example, in some embodiments, the CMF of the multicore optical fiber 110 may range from about 0.028 to about 0.043, from about 0.028 to about 0.040, from about 0.028 to about 0.037, from about 0.028 to about 0.035, from about 0.028 to about 0.033, from about 0.03 to about 0.045, from about 0.03 to about 0.043, from about 0.03 to about 0.04, from about 0.03 to about 0.037, from about 0.03 to about 0.035, from about 0.03 to about 0.033, from about 0.033 to about 0.045, from about 0.033 to about 0.043, from about 0.033 to about 0.040, from about 0.033 to about 0.037, from about 0.033 to about 0.035, from about 0.035 to about 0.045, from about 0.035 to about 0.043, from about 0.035 to about 0.041, from about 0.035 to about 0.039, from about 0.035 to about 0.037, from about 0.037 to about 0.045, from about 0.037 to about 0.043, from about 0.037 to about 0.041, or from about 0.037 to about 0.039.

The arrangement or configuration of core portions C within in the common cladding 19, as well as the associated CMF described herein, may reduce crosstalk, radiation loss, and/or attenuation while increasing transmission capacity. For example, with the configuration of the core portions C within the common cladding 19 and/or the CMF values described herein, each core portion Cᵢ may have an attenuation of less than 0.165 dB/km and a radiation loss of less than 0.01 dB/km at a wavelength of 1550 nm. Further, a counter-propagating crosstalk between two adjacent core portions may be less than or equal to −40 dB per 100 km, thereby allowing for uncoupled bidirectional transmission using the multicore optical fiber 110 described herein.

For bidirectional (or counterpropagating) transmission, such as discussed above with reference to FIG. 1, a first plurality of core portions and a second plurality of core portions may be utilized for transmission in opposite directions over the multicore optical fiber 110. In some embodiments, adjacent core portions may be configured for transmission in opposite directions. In some embodiments, the first plurality of core portions and the second plurality of core portions may be arranged in an alternating manner. For exempla, in the exemplary embodiment shown in FIG. 2, the first plurality of core portions C₁, C₃, C₅, and C₇ of the multicore optical fiber 110 may be configured for transmission in a first direction, and the second plurality of core portions C₂, C₄, C₆, and C₈ may be configured for transmission in a second direction opposite the first direction. At the first end 112 of the multicore optical fiber 110, the first plurality of core portions C₁, C₃, C₅, and C₇ may be coupled to the plurality of light sources of the first transceiver 180, and the second plurality of core portions C₂, C₄, C₆, and C₈ may be coupled to the plurality of detectors of the first transceiver 180. At the second end 114 of the multicore optical fiber 110, the first plurality of core portions C₁, C₃, C₅, and C₇ may be optically coupled to the plurality of detectors of the second transceiver 190, and the second plurality of core portions C₂, C₄, C₆, and C₈ may be optically coupled to the plurality of light sources of the second transceiver 190.

In some embodiments, the first plurality of core portions may include greater than or equal to 3 core portions, greater than or equal to 4 coating portions, or greater than or equal to 5 core portions. In some embodiments, the first plurality of core portions may less than or equal to 5 coating portions, less than or equal to 4 core portions, or less than or equal to 3 core portions. In some embodiments, the first plurality of core portions may include greater than or equal to 3 core portions and less than or equal to 5 core portions, greater than or equal to 3 core portions and less than or equal to 4 core portions, or greater than or equal to 4 core portions and less than or equal to 5 core portions. In some embodiments, the second plurality of core portions may include greater than or equal to 3 core portions, greater than or equal to 4 coating portions, or greater than or equal to 5 core portions. In some embodiments, the second plurality of core portions may less than or equal to 5 coating portions, less than or equal to 4 core portions, or less than or equal to 3 core portions. In some embodiments, the second plurality of core portions may include greater than or equal to 3 core portions and less than or equal to 5 core portions, greater than or equal to 3 core portions and less than or equal to 4 core portions, or greater than or equal to 4 core portions and less than or equal to 5 core portions. In some embodiments, the first plurality of core portions and the second plurality of core portions may include equal number of core portions. In some embodiments, the first plurality of core portions and the second plurality of core portions may include different number of core portions, depending on the application.

In some embodiments, such as the exemplary embodiment shown in FIG. 2, the core portions may be arranged around the central fiber axis 12, and no core portion may be positioned at or aligned with the central fiber axis 12 of the multicore optical fiber 110. In some embodiments, the multicore optical fiber 110 may include a core portion with its core centerline aligned with the central fiber axis 12. In some embodiments, all of the core portions may be arranged at an equal radial distance from the central fiber axis 12 of the multicore optical fiber 110. In some embodiments, one or more of the core portions may be positioned at a radial distance from the central fiber axis 12 that may be different from the radial distance at which another one or more of the core portions may be positioned. In some embodiments, two or more core portions may be arranged along a circle having an axis aligned with the central fiber axis 12, and the two or more core portions may be equally spaced apart along the circumference of the circle in some embodiments. In some embodiments, the two or more core portions may be spaced apart along the circumference of the circle by different distances. Although exemplary arrangement of core portions within the common cladding 19 are shown and described herein, these embodiments are not intended to be limiting, and other arrangement of the core portions within the common cladding 19 may be contemplated.

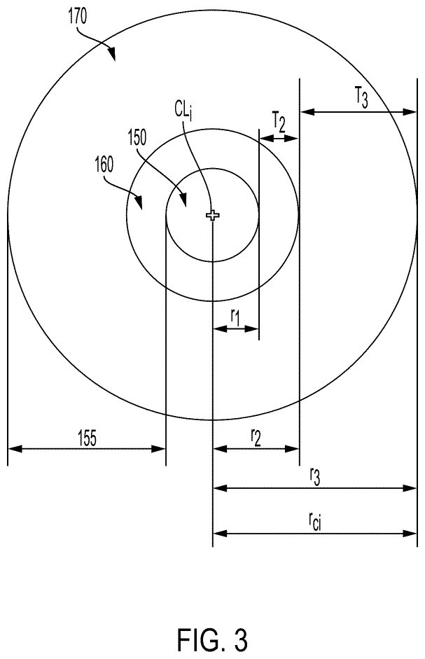

FIG. 3 schematically depicts a radial cross section of an exemplary core portions Cᵢ viewed along line II-II of FIG. 1, according to some embodiments. In some embodiments, each of the core portions Cᵢ may include a core region 150 centered on a central axis CLᵢ and a cladding region 155 encircling and directly contacting the core region 150. In some embodiments, the core region 150 and the cladding region 155 may be concentric such that the cross section of the core portion Cᵢ may be generally circular symmetric with respect to the centerline CLᵢ having an overall radius r_{Ci}. The cladding region 155 may include an inner cladding region 160 (also referred to herein as an inner cladding layer) encircling and directly contacting the core region 150, and a trench region 170 encircling and directly contacting the inner cladding region 160. The common cladding 19 may encircle and direct contract the trench region 170 of each core portion Cᵢ and extend from the outer radius r₃ of the trench region 170. Referring back to FIG. 2, the common cladding 19 may extend from the outer radius r₃ of the trench region 170 to the outer radius R_{CC} of the common cladding 19. The common cladding 19 may also extend from the outer radius r₃ of the trench region 170 to the central axis 12 of the multicore optical fiber 110 and the other core portions such that the core portions may be embedded in the common cladding 19 of the multicore optical fiber 110.

The core region 150 may extend from the central axis CLᵢ to an outer radius r₁. The inner cladding region 160 may extend from the outer radius r₁ of the core region 150 to an outer radius r₂. The outer radius r₁ of the core region 150 may coincide with the inner radius of the inner cladding region 160. The trench region 170 may extend from the outer radius r₂ of the inner cladding region 160 to an outer radius r₃. The outer radius r₂ of the inner cladding region 160 may coincide with the inner radius of the trench region 170. The outer radius r₃ of the trench region 170 may coincide with the radius r_{Ci} associated with each core portion Cᵢ.

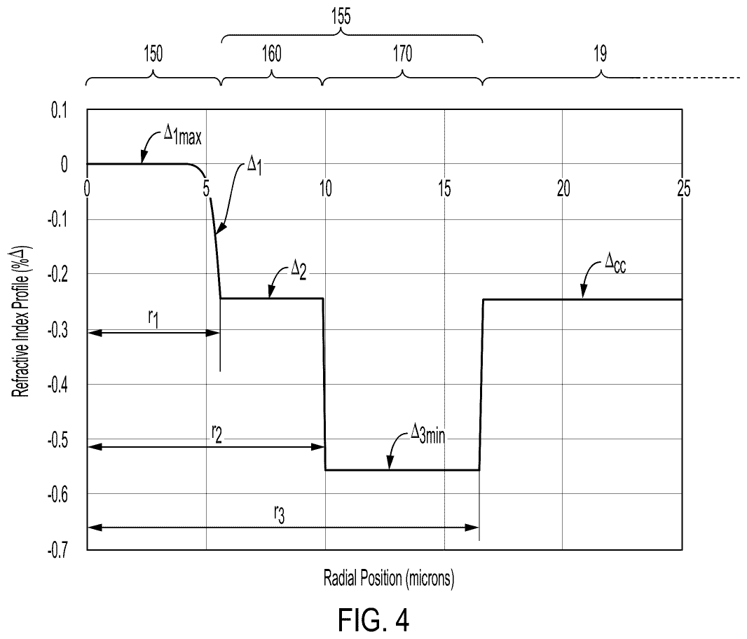

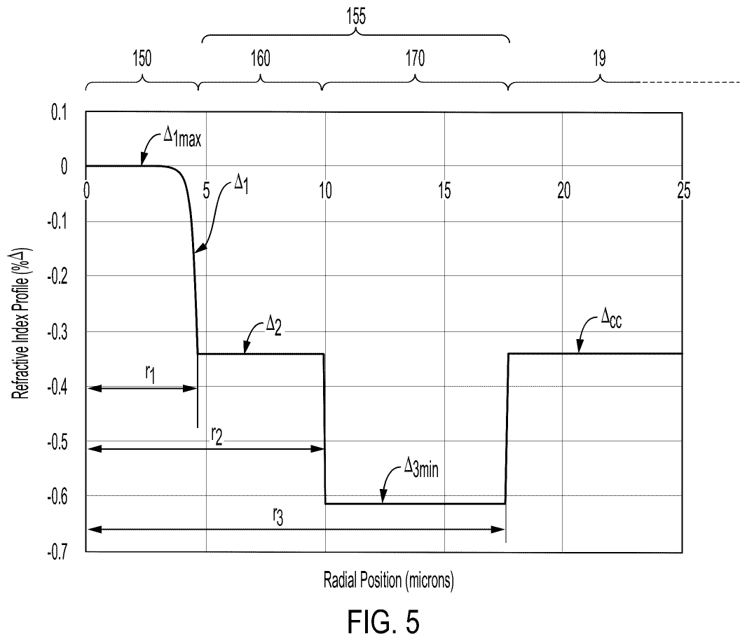

FIGS. 4 and 5 graphically depict exemplary relative refractive index profiles (relative to pure silica) of a core portion C₁ and the surrounding common cladding 19, according to some embodiments. The relative refractive index profiles of each core portion C₁ are plotted as a function of radial distance r from the centerline CLᵢ of the core portion Cᵢ. Each of the relative refractive index profiles depicted in FIGS. 4 and 5 extend radially outward from a centerline CLᵢ of the core portion Ci and into a portion of the common cladding 19.

As depicted in FIGS. 4 and 5, the core region 150 has a relative refractive index Δ₁ relative to pure silica. In some embodiments, the relative refractive index Δ₁ may vary with radial coordinate (radius) r and be represented as Δ₁(r). The relative refractive index Δ₁ of the core region 150 may be greater than the relative refractive indices of other regions of the core portion Cᵢ, such as the relative refractive index Δ₂ of the inner cladding region 160 and/or the relative refractive index Δ₃ of the trench region 170 of the core portion C₁ as will be discussed in more detail below. In some embodiments, the relative refractive index Δ₁ may also be greater than the relative refractive index Δ_{CC} of the common cladding 19 of the multicore optical fiber 110.

In some embodiments, the core region 150 may include silica-based glass having an up-dopant. In some embodiments, the core region 150 may include silica-based glass doped with at least one alkali. In some embodiments, the core region 150 may include silica-based glass doped with one or more alkali chosen from a group comprising lithium, sodium, potassium, rubidium or a combination thereof. In some embodiments, the dopant consists of lithium, sodium, potassium, rubidium or a combination thereof. In some embodiments, the dopant consists essentially of lithium, sodium, potassium, rubidium or a combination thereof. In some embodiments, the core region 150 may include silica-based glass doped with sodium and potassium.

The average concentration of the alkali dopant in the core region 150 is defined as:

$${C}_{alkali , avg} = \frac{8 {\int }_{0}^{MFD / 2} {C}_{alkali} ( r ) rdr}{MFD}$$

where Cₐₗₖₐₗᵢ(r) is the concentration of the alkali as a function of radial distance from the center of the core region 150 and MFD is the mode field diameter of the core region 150 at the wavelength of interest (here considered as 1550 nm). In some embodiments, the average concentration of alkali in the core region 150 may be in the range from 10 ppm to 500 ppm, or from 20 ppm to 500 ppm, or from 25 ppm to 400 ppm, or from 50 ppm to 300 ppm. Because the core region 150 may include a maximum average alkali concentration of 500 ppm, the alkali dopant may only slightly increase the refractive index of the core region 150. Therefore, the core region 150 may still be able to effectively achieve a refractive index of about 0% even with such alkali up-doping. When core region 150 includes two or more alkali dopants (such as both potassium and rubidium), the average concentration of alkali dopant is the sum of the average concentration of each of the individual alkali dopants. In some embodiments, the silica glass of core region 150 may be free or substantially free of germanium and/or chlorine, and the core region 150 may include silica glass that may lack germanium and/or chlorine.

In some embodiments, the relative refractive index Δ₁(r) of the core region 150 may include a maximum relative refractive index Δ₁ₘₐₓ. In some embodiments, the maximum relative refractive index Δ₁ₘₐₓ of the core region 150 may be in a range from about −0.20% to about 0.20%, or in a range from about −0.15% to about 0.15%, or in a range from about −0.10% to about 0.10%, or in a range from about −0.05% to about 0.05%. In some embodiments, the relative refractive index Δ₁ₘₐₓ may be about 0.0%. The relative refractive index Δ₁ₘₐₓ may be preferably constant or approximately constant.

In some embodiments, the relative refractive index Δ₁(r) follows a graded index profile. The relative refractive index of each core region 150 may be described by an a-profile with an a value that may be in a range of about 7.0 or less, or about 6.0 or less, or about 5.0 or less, or about 4.0 or less, or about 3.0 or less, or about 2.0 or less, or about 1.0 or less. In some other embodiments, the a value may be about 8.0 or greater, or about 9.0 or greater, or about 10.0 or greater, or about 11.0 or greater, or about 12.0 or greater, or about 13.0 or greater. In some embodiments, the core region α value may be about 10, or about 12, or about 20. Therefore, core region 150 can have either a graded-index profile or a step-index profile. For example, in some embodiments, the maximum relative refractive index Δ₁ₘₐₓ may occur at r=0 (e.g., at the centerline CLᵢ) and decrease with an alpha profile until reaching the radius r₁. In some embodiments, the relative refractive index Δ₁ (r) may follow a step index profile. For example, in some embodiments, the relative refractive index Δ₁ (r) may remain substantially equal to the maximum relative refractive index Δ₁ₘₐₓ until the radius r₁.

In some embodiments, the outer radius r₁ of the core region 150 may be greater than or equal to 3.0 microns and less than or equal to 7.0 microns—including all sub-ranges and values there-between. For example, in some embodiments, the outer radius r₁ of the core region 150 may be greater than or equal to 3.5 microns and less than or equal to 6.5 microns, greater than or equal to 3.5 μm and less than or equal to 6 μm, greater than or equal to 4.0 μm and less than or equal to 6.0 μm. Providing a core radius r₁ within this range facilitates each core portion C₁ having a mode field diameter at 1550 nm greater than or equal to 9.5 μm and less than or equal to 13.5 μm.

Referring still to FIGS. 4 and 5, the inner cladding region 160 may extend from radius r₁ to radius r₂ such that the inner cladding region 160 may have a radial thickness T₂=r₂-r₁. In some embodiments, the inner cladding region 160 may be formed from silica-based glass and have a relative refractive index Δ₂. In some embodiments, the inner cladding region 160 may include silica-based glass doped with down-dopants such that the relative refractive index Δ₂ may be less than 0. For example, in some embodiments, inner cladding region 160 may be down-doped with fluorine or boron. In some embodiments, the relative refractive index Δ₂ of the inner cladding region 160 may be similar to or the same as the relative refractive index Δ_{CC} of the common cladding 19. In some embodiments, a difference between the relative refractive index Δ₂ of the inner cladding region 160 and the relative refractive index Δ_{CC} of the common cladding 19 may range from about −0.05% to about 0.05%.

Without wishing to be bound by theory, it is believed that the value of r₂ (and hence the radial thickness T₂ of the inner cladding region 160) may in part determine the dispersion properties of each of the core portions Cᵢ and ability to achieve high mode field diameter with acceptable cutoff and bending properties. In some embodiments, the outer radius r₂ of the inner cladding region 160 may be greater than or equal to 7 μm and less than or equal to 15 μm—including all sub-ranges and values there-between. For example, in some embodiments, the outer radius r₂ of the inner cladding region 160 may be greater than or equal to 7 μm and less than or equal to 14 μm, or greater than or equal to 8 μm and less than or equal to 14 μm, or greater than or equal to 9 μm and less than or equal to 13 μm, or greater than or equal to 10 μm and less than or equal to 12 μm, or greater than or equal to 8 μm and less than or equal to 13 μm, or or greater than or equal to 8 μm and less than or equal to 11 μm.

The relative refractive index Δ₂ of inner cladding region 160 may be in a range from about −0.20% to about −0.40%, or in a range from about −0.20% to about −0.30%, or in a range from about −0.21% to about −0.38%, or in a range from about −0.22% to about −0.36%, or in a range from about −0.25% to about −0.33%. In some embodiments, the relative refractive index Δ₂ may be about −0.25%, or about −0.26%, or about −0.31%, or about −0.34%, or about −0.35%. The relative refractive index Δ₂ may be preferably constant or approximately constant.

With further reference to FIGS. 4 and 5, the trench region 170 may extend from the radius r₂ to the radius r₃ such that the trench region 170 may have a radial thickness T₃=r₃−r₂. Without wishing to be bound by theory, it is believed that the value of r₃ (and hence the radial thickness T₃ of the trench region 170) may in part determine bend loss of each of the core portions C₁ and inter-core crosstalk between the core portions. To achieve such optical properties, in some embodiments, the outer radius r₃ of the trench region 170 may be greater than or equal to 7 μm and less than or equal to 20 μm—including all sub-ranges and values there-between. For example, in some embodiments, the outer radius r₃ of the trench region 170 may be greater than or equal to 7 μm and less than or equal to 17 μm, greater than or equal to 7 μm and less than or equal to 13 μm, greater than or equal to 7 μm and less than or equal to 10 μm, greater than or equal to 10 μm and less than or equal to 20 μm, greater than or equal to 10 μm and less than or equal to 17 μm, greater than or equal to 10 μm and less than or equal to 13 μm, greater than or equal to 13 μm and less than or equal to 20 μm, greater than or equal to 13 and less than or equal to 17 μm, or greater than or equal to 17 μm and less than or equal to 20 μm.

The trench region 170 has a relative refractive index Δ₃. In some embodiments, the relative refractive index Δ₃ may be less than or equal to the relative refractive index Δ₂ of the inner cladding region 160 throughout the trench region 170. The relative refractive index Δ₃ may also be less than or equal to the relative refractive index Δ_{CC} of the common cladding 19. Accordingly, in some embodiments, Δ₂>Δ₃ and Δ_{CC}>Δ₃ such that the trench region 170 may form a depressed-index trench in a relative refractive index profile of each core portion between r₂ and r₃.

The term “trench,” as used herein, refers to a region of the core portion that is, in radial cross section, surrounded by regions of the multicore fiber (e.g., the inner cladding region 160 and the common cladding 19) having relatively higher refractive indexes. In some embodiments, the trench region 170 may include silica glass having one or more down-dopants (e.g., fluorine). In some embodiments, the down-dopant concentration within the trench region 170 may vary as a function of radial distance from the centerline CLᵢ of the core portion Cᵢ.

In some embodiments, the relative refractive index Δ₃ may be substantially constant throughout the trench region 170. In other words, the relative refractive index Δ₃ of the trench region 170 may remain substantially constant from the radius r₂ to the radius r₃ such that the trench region 170 may have a substantially rectangular shape. In other embodiments, the relative refractive index Δ₃ may vary with radial coordinate r (radius) and be represented as Δ₃(r).

Still referring to FIGS. 4 and 5, in some embodiments, the relative refractive index Δ₃(r) of the trench region 170 may include a minimum relative refractive index Δ₃ₘᵢₙ. In some embodiments, the trench region 170 may include a minimum relative refractive index Δ₃ₘᵢₙ at radium r₃. In some embodiments, a minimum relative refractive index Δ₃ₘᵢₙ may be maintained or substantially maintained throughout the trench region 170, such as from the outer radius r₂ of the inner cladding region 160 to the outer radius r₃ of the trench region 170.

In some embodiments, the relative refractive index Δ₃ or the minimum relative refractive index Δ₃ₘᵢₙ of the trench region 170 may be in a range from about −0.25% to about −0.7%—including all sub-ranges and values there-between. For example, in some embodiments, the relative refractive index Δ₃ or the minimum relative refractive index Δ₃ₘᵢₙ of the trench region 170 may be in a range from about −0.25% to about −0.6%, from about −0.25% to about −0.5%, from about −0.25% to about −0.4%, from about −0.25% to about −0.3%, from about −0.3% to about −0.7%, from about −0.3% to about −0.6%, from about −0.3% to about −0.5%, from about −0.3% to about −0.4%, from about −0.4% to about −0.7%, from about −0.4% to about −0.6%, from about −0.4% to about −0.5%, from about −0.5% to about −0.7%, from about −0.5% to about −0.6%, or from about −0.6% to about −0.7%.

In some embodiments, each core portion Cᵢ may be fabricated such that the relative refractive index Δ₃ of the trench region 170 may be determined by a down-dopant concentration D that varies with radial coordinate r, i.e., D=D(r). In some embodiments, the down-dopant may include fluorine and D(r) may be expressed as a radially-dependent fluorine concentration F(r). As such, F(r) within the trench region 170 may vary between a minimum value Fₘᵢₙ and a maximum value Fₘₐₓ. In some embodiments, Fₘᵢₙ may be at the radial position r₂ and Fₘₐₓ may be at the radial position r₃. In some embodiments, Fₘₐₓ may be greater than or equal to 1.2 wt. % and less than or equal to 2.2 wt. %. In some embodiments, Fₘₐₓ may be greater than or equal to 1.5 wt. % and less than or equal to 2.2 wt. %. The values of the down-dopant concentrations (e.g., Fₘₐₓ and Fₘᵢₙ) within the trench region 170 may determine the refractive index profile therein, and therefore the trench volume of the trench region 170 in FIGS. 3, 4, and 5.

Without wishing to be bound by theory, it is believed that the trench volume may influence one or more of cable cutoff, mode field diameter, effective area, dispersion, bend loss, and/or inter-core crosstalk of the core portions Cᵢ. For example, the core designs as described herein may provide a trench volume within the trench region 170 of each core portion C₁ to be greater than or equal to 5%Δ μm² and less than or equal to 60%Δ μm² to achieve effective area of between 75 μm² and 135 μm², cable cutoff of less than 1530 nm, dispersion at 1550 nm of between 18 ps/nm/km and 22 ps/nm/km, and/or crosstalk less than −40 dB/100 km.

In some embodiments, the trench region 170 may include a trench volume greater than or equal to 5%Δ micron², greater than or equal to 10%Δ micron², greater than or equal to 15%Δ micron², greater than or equal to 20%Δ micron², greater than or equal to 25%Δ micron², greater than or equal to 30%Δ micron², greater than or equal to 35%Δ micron², greater than or equal to 40%Δ micron², greater than or equal to 45%Δ micron², greater than or equal to 50%Δ micron², or greater than or equal to 55%Δ micron². In some embodiments, the trench region 170 may include a trench volume less than or equal to 60%Δ micron², less than or equal to 55.5%Δ micron², less than or equal to 50%Δ micron², less than or equal to 45%Δ micron², less than or equal to 40%Δ micron², less than or equal to 35%Δ micron², less than or equal to 30%Δ micron², less than or equal to 25%Δ micron², less than or equal to 20%Δ micron², or less than or equal to 15%Δ micron².

In some embodiments, the trench region 170 may include a trench volume greater than or equal to 5%Δ micron² and less than or equal to 60%Δ micron²—including all sub-ranges and values there-between. For example, in some embodiments, the trench region 170 may include a trench volume greater than or equal to 5%Δ micron² and less than or equal to 55.5%Δ micron², greater than or equal to 5%Δ micron² and less than or equal to 45%Δ micron², greater than or equal to 5%Δ micron² and less than or equal to 35%Δ micron², greater than or equal to 5%Δ micron² and less than or equal to 25%Δ micron², greater than or equal to 5%Δ micron² and less than or equal to 15%Δ micron², greater than or equal to 15%Δ micron² and less than or equal to 60%Δ micron², greater than or equal to 15%Δ micron² and less than or equal to 55.5%Δ micron², greater than or equal to 15%Δ micron² and less than or equal to 45%Δ micron², greater than or equal to 15%Δ micron² and less than or equal to 35%Δ micron², greater than or equal to 15%Δ micron² and less than or equal to 25%Δ micron², greater than or equal to 25%Δ micron² and less than or equal to 60%Δ micron², greater than or equal to 25%Δ micron² and less than or equal to 55.5%Δ micron², greater than or equal to 25%Δ micron² and less than or equal to 45%Δ micron², greater than or equal to 25%Δ micron² and less than or equal to 35%Δ micron², greater than or equal to 35%Δ micron² and less than or equal to 60%Δ micron², greater than or equal to 35%Δ micron² and less than or equal to 55.5%Δ micron², greater than or equal to 35%Δ micron² and less than or equal to 45%Δ micron², greater than or equal to 45%Δ micron² and less than or equal to 60%Δ micron², or greater than or equal to 45%Δ micron² and less than or equal to 55.5%Δ micron².

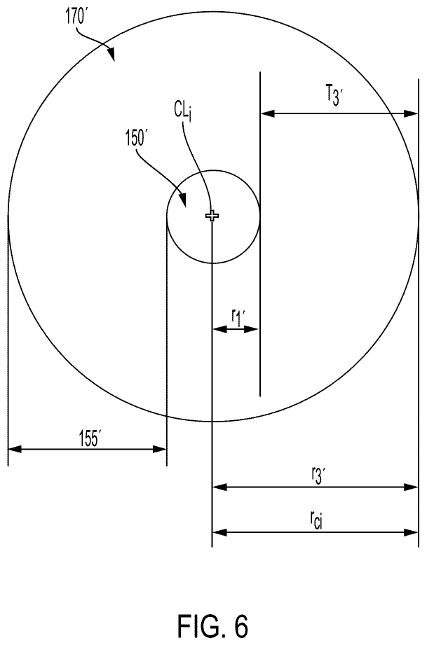

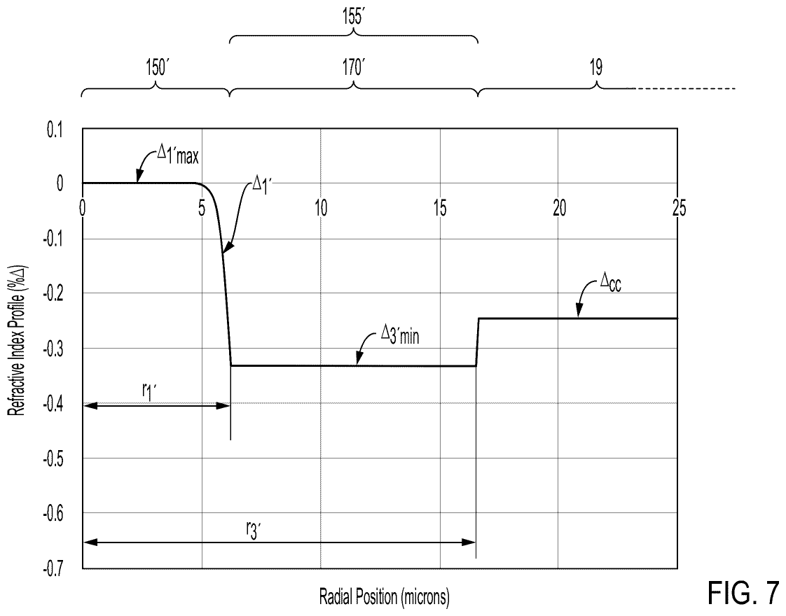

FIG. 6 schematically depicts a radial cross section of another exemplary core portions Cᵢ viewed along line II-II of FIG. 1, according to some embodiments. FIG. 7 graphically depicts an exemplary relative refractive index profile (relative to pure silica) of a core portion Cᵢ (such as the exemplary core portion Cᵢ described herein with reference to FIG. 6) and the surrounding common cladding 19, according to some embodiments. The relative refractive index profile of the core portion Cᵢ is plotted as a function of radial distance r from the centerline CLᵢ of the core portion Cᵢ, and extends radially outward from the centerline CLᵢ of the core portion Cᵢ and into a portion of the common cladding 19.

Similar to the core portion Cᵢ described with reference to FIGS. 3, 4, and 5, in some embodiments, the core portion Cᵢ depicted in FIG. 6 may include a core region 150′ centered on a central axis CLᵢ and a cladding region 155′ encircling and directly contacting the core region 150′. In some embodiments, the core region 150′ and the cladding region 155′ may be concentric such that the cross section of the core portion Cᵢ may be generally circular symmetric with respect to the centerline CLᵢ having the overall radius r_{Ci}.

Different from the core portion Cᵢ described with reference to FIGS. 3, 4, and 5, the cladding region 155′ of the exemplary embodiment of FIG. 6 may include only one region, i.e., the trench region 170′ that may encircle and directly contact the core region 150′. In other words, in some embodiments, the core portion Cᵢ, such as the core portion Cᵢ shown in FIG. 6, may not include an inner cladding region, such as the inner cladding region 160 described above with references to FIGS. 3, 4, and 5. The common cladding 19 may encircle and direct contact the trench region 170′ (as shown in FIG. 7).

With further reference to FIGS. 6 and 7, the core region 150′ may have an outer radius r_{1′}. The trench region 170′ may extend from the outer radius r_{1′} of the core region 150′ to an outer radius r_{3′} such that the outer radius r_{1′} of the core region 150′ may coincide with the inner radius of the trench region 170′. The outer radius r_{3′} of the trench region 170′ may define an outer radius of the core portion Cᵢ such that the outer radius r_{3′} of the trench region 170′ may correspond to the radius r_{Ci} associated with each core portion Cᵢ.

The outer radius r_{1′} of the core region 150′ may be greater than or equal to 3.0 microns and less than or equal to 7.0 microns—including all sub-ranges and values there-between. For example, in some embodiments, the outer radius r_{1′} of the core region 150′ may be in a range from about 3.5 μm to about 6.5 μm, from about 3.5 μm to about 6 μm, from about 4.0 μm to about 6.0 μm.

In some embodiments, the outer radius r_{3′} of the trench region 170′ may be greater than or equal to 7 μm and less than or equal to 20 μm—including all sub-ranges and values there-between. For example, in some embodiments, the outer radius r_{3′} of the trench region 170′ may be greater than or equal to 7 μm and less than or equal to 17 μm, greater than or equal to 7 μm and less than or equal to 13 μm, greater than or equal to 7 μm and less than or equal to 10 μm, greater than or equal to 10 μm and less than or equal to 20 μm, greater than or equal to 10 μm and less than or equal to 17 μm, greater than or equal to 10 μm and less than or equal to 13 μm, greater than or equal to 13 μm and less than or equal to 20 μm, greater than or equal to 13 and less than or equal to 17 μm, or greater than or equal to 17 μm and less than or equal to 20 μm.

The trench region 170′ may have a thickness T_{3′}=r_{3′}−r_{1′} in the radial direction. The thickness T_{3′} may be greater than or equal to 6 μm and less than or equal to 16 μm—including all sub-ranges and values there-between. For example, in some embodiments, the thickness T_{3′} of the trench region 170′ may range from about 6 μm to about 14 μm, from about 6 μm to about 12 μm, from about 6 μm to about 10 μm, from about 6 μm to about 8 μm, from about 8 μm to about 16 μm, from about 8 μm to about 14 μm, from about 8 μm to about 12 μm, from about 8 μm to about 10 μm, from about 10 μm to 16 μm, from about 10 μm to about 14 μm, from about 10 μm to about 12 μm, from about 12 μm to about 16 μm, from about 12 μm to about 14 μm, or from about 14 μm to about 16 μm.

The core region 150′ may include a refractive index similar to that of the core region 150 described above with reference to FIGS. 3, 4, and 5. In some embodiments, the core region 150′ may include a silica-based glass having one or more up-dopants, such as one or more alkali chosen from a group comprising lithium, sodium, potassium, rubidium or a combination thereof, and have a relative refractive index Δ_{1′} relative to pure silica. The relative refractive index Δ_{1′} of the core region 150′ may be greater than the relative refractive index Δ_{3′} of the trench region 170′ of the core portion Cᵢ. In some embodiments, the relative refractive index Δ_{1′} may also be greater than the relative refractive index Δ_{CC} of the common cladding 19 of the multicore optical fiber 110. In some embodiments, the relative refractive index Δ_{1′} may vary with radial coordinate (radius) r and be represented as Δ_{1′}(r). In some embodiments, the relative refractive index Δ_{1′}(r) of the core region 150′ may include a maximum relative refractive index Δ_{1′max}. In some embodiments, the maximum relative refractive index Δ_{1′max} of the core region 150′ may be in a range from about −0.20% to about 0.20%, or in a range from about −0.15% to about 0.15%, or in a range from about −0.10% to about 0.10%, or in a range from about −0.05% to about 0.05%.

In some embodiments, the trench region 170′ may be formed from silica-based glass doped with down-dopants (e.g., fluorine or boron) such that the trench region 170′ may have a relative refractive index Δ_{3′} less than 0. The relative refractive index Δ_{3′} of the trench region 170′ may include a minimum relative refractive index Δ_{3′min}. The minimum relative refractive index Δ_{3′min} of the trench region 170′ depicted in FIG. 7 may be greater than the minimum relative refractive index Δ₃ₘᵢₙ of the trench region 170 described with reference to FIGS. 3, 4, and 5 but less than the relative refractive index Δ_{CC} of the common cladding 19.

In some embodiments, the difference between the refractive index Δ_{CC} of the common cladding region 19 and the minimum relative refractive index Δ_{3′min} of the trench region 170′ may be in a range from about −0.02% to about −0.5%—including all sub-ranges and values there-between. For example, in some embodiments, the difference in the refractive index of the common cladding region 19 and the minimum relative refractive index Δ_{3′minimum} of the trench region 170′ may be in a range from about −0.02% to about −0.45%, from about −0.02% to about −0.4%, from about −0.02% to about −0.35%, from about −0.02% to about −0.3%, from about −0.02% to about −0.25%, from about −0.02% to about −0.2%, from about −0.02% to about −0.1%, from about −0.02% to about −0.05%, from about −0.05% to about −0.5%, from about −0.05% to about −0.45%, from about −0.05% to about −0.4%, from about −0.05% to about −0.35%, from about −0.05% to about −0.3%, from about −0.05% to about −0.25%, from about −0.05% to about −0.2%, from about −0.05% to about −0.1%, from about −0.05% to about −0.05%, from about −0.1% to about −0.5%, from about −0.1% to about −0.45%, from about −0.1% to about −0.4%, from about −0.1% to about −0.35%, from about −0.1% to about −0.3%, from about −0.1% to about −0.25%, from about −0.1% to about −0.2%, from about −0.15% to about −0.5%, from about −0.15% to about −0.45%, from about −0.15% to about −0.4%, from about −0.15% to about −0.35%, from about −0.15% to about −0.3%, from about −0.15% to about −0.25%, from about −0.15% to about −0.2%, from about −0.2% to about −0.5%, from about −0.2% to about −0.45%, from about −0.2% to about −0.4%, from about −0.2% to about −0.35%, from about −0.2% to about −0.3%, from about −0.2% to about −0.25%, from about −0.25% to about −0.5%, from about −0.25% to about −0.45%, from about −0.25% to about −0.4%, from about −0.25% to about −0.35%, from about −0.25% to about −0.3%, from about −0.3% to about −0.5%, from about −0.3% to about −0.45%, from about −0.3% to about −0.4%, from about −0.3% to about −0.35%, from about −0.35% to about −0.5%, from about −0.35% to about −0.45%, from about −0.35% to about −0.4%, from about −0.4% to about −0.5%, from about −0.4% to about −0.45%, or from about −0.45% to about −0.5%. The relative refractive index Δ₃, may be preferably constant or approximately constant. The performance of the relative refractive profiles depicted in FIGS. 4, 5, and 7, as well as specific values associated therewith, will be described in more detail below.

In some embodiments, the trench region 170′ may include a trench volume greater than or equal to 3%Δ micron², greater than or equal to 15%Δ micron², greater than or equal to 30%Δ micron², greater than or equal to 45%Δ micron². In some embodiments, the trench region 170′ may include a trench volume less than or equal to 60%Δ micron², less than or equal to 50%Δ micron², less than or equal to 35%Δ micron², or less than or equal to 20%Δ micron². In some embodiments, the trench region 170′ may include a trench volume greater than or equal to 3%Δ micron² and less than or equal to 60%Δ micron²—including all sub-ranges or values therebetween. For example, in some embodiments, the trench region 170′ may include a trench volume greater than or equal to 3%Δ micron² and less than or equal to 45%Δ micron², greater than or equal to 3%Δ micron² and less than or equal to 30%Δ micron², greater than or equal to 3%Δ micron² and less than or equal to 15%Δ micron², greater than or equal to 20%Δ micron² and less than or equal to 60%Δ micron², greater than or equal to 20%Δ micron² and less than or equal to 45%Δ micron², greater than or equal to 20%Δ micron² and less than or equal to 30%Δ micron², greater than or equal to 35%Δ micron² and less than or equal to 60%Δ micron², greater than or equal to 35%Δ micron² and less than or equal to 45%Δ micron², or greater than or equal to 50%Δ micron² and less than or equal to 60%Δ micron².

In some embodiments, the various designs of the core portion C₁ described herein may produce core portions C₁ with cable cutoff values of less than or equal to 1530 nm to allow for single-mode operation at 1550 nm. In some embodiments, the cable cutoff of each core portion C₁ may be less than or equal to 1530 nm, less than or equal to 1500 nm, less than or equal to 1450 nm, less than or equal to 1400 nm, or less than or equal to 1350 nm. In some embodiments, the cable cutoff of each core portion C₁ may be greater than or equal to 1300 nm and less than or equal to 1530 nm—including all sub-ranges and values there-between. For example, in some embodiments, the cable cutoff of each core portion C₁ may be greater than or equal to 1300 nm and less than 1500 nm, greater than or equal to 1300 nm and less than 1450 nm, greater than or equal to 1300 nm and less than or equal to 1400, greater than or equal to 1350 nm and less than 1530 nm, greater than or equal to 1350 nm and less than 1500 nm, greater than or equal to 1350 nm and less than 1450 nm, greater than or equal to 1350 nm and less than or equal to 1400 nm, greater than or equal to 1400 nm and less than 1530 nm, greater than or equal to 1400 nm and less than 1500 nm, or greater than or equal to 1400 nm and less than 1450 nm.

In some embodiments, each core portion Cᵢ of the multicore optical fiber 110 may have an effective area A_{eff} at 1550 nm wavelength greater than or equal to 75 μm², greater than or equal to 80 μm², greater than or equal to 85 μm², greater than or equal to 90 μm², greater than or equal to 95 μm², greater than or equal to 100 μm², greater than or equal to 105 μm², greater than or equal to 110 μm², greater than or equal to 115 μm², greater than or equal to 120 μm², greater than or equal to 125 μm², or greater than or equal to 130 μm². In some embodiments, each core portion Cᵢ of the multicore optical fiber 110 may have an effective area A_{eff} at 1550 nm wavelength less than or equal to 135 μm², less than or equal to 130 μm², less than or equal to 125 μm², less than or equal to 120 μm², less than or equal to 115 μm², less than or equal to 110 μm², less than or equal to 105 μm², less than or equal to 100 μm², less than or equal to 95 μm², less than or equal to 90 μm², less than or equal to 85 μm², or less than or equal to 80 μm².

In some embodiments, each core portion Cᵢ of the multicore optical fiber 110 may have an effective area A_{eff} at 1550 nm wavelength greater than or equal to 75 μm² and less than or equal to 135 μm²—including all sub-ranges and values there-between. For example, in some embodiments, each core portion Cᵢ of the multicore optical fiber 110 may have an effective area A_{eff} at 1550 nm wavelength greater than or equal to 80 μm² and less than or equal to 135 μm², greater than or equal to 90 μm² and less than or equal to 135 μm², greater than or equal to 100 μm² and less than or equal to 135 μm², greater than or equal to 110 μm² and less than or equal to 135 μm², greater than or equal to 75 μm² and less than or equal to 130 μm², greater than or equal to 80 m² and less than or equal to 130 μm², greater than or equal to 85 μm² and less than or equal to 130 μm², greater than or equal to 90 μm² and less than or equal to 130 μm², greater than or equal to 95 μm² and less than or equal to 130 μm², greater than or equal to 100 μm² and less than or equal to 130 μm², greater than or equal to 110 μm² and less than or equal to 130 μm², greater than or equal to 75 μm² and less than or equal to 125 μm², greater than or equal to 80 μm² and less than or equal to 125 μm², greater than or equal to 90 μm² and less than or equal to 125 μm², greater than or equal to 100 μm² and less than or equal to 125 μm², greater than or equal to 110 μm² and less than or equal to 125 μm², greater than or equal to 80 μm² and less than or equal to 120 μm², greater than or equal to 80 μm² and less than or equal to 110 μm², greater than or equal to 90 μm² and less than or equal to 120 μm², greater than or equal to 90 μm² and less than or equal to 110 μm², or greater than or equal to 100 μm² and less than or equal to 120 μm², greater than or equal to 75 μm² and less than or equal to 115 μm², greater than or equal to 80 μm² and less than or equal to 115 μm², greater than or equal to 90 μm² and less than or equal to 115 μm², greater than or equal to 100 μm² and less than or equal to 115 μm², or greater than or equal to 110 μm² and less than or equal to 115 μm². The effective area is determined individually for each core portion Cᵢ of the multicore optical fiber 110 without consideration of the effects of crosstalk between the core portions Cᵢ of the multicore optical fiber 110.

In some embodiments, the core region 150 disclosed herein may have a mode field diameter at 1550 nm wavelength greater than or equal to 9.5 μm, greater than or equal to 10.5 μm, greater than or equal to 11.5 μm, or greater than or equal to 12.5 μm. In some embodiments, the core region 150 disclosed herein may have a mode field diameter at 1550 nm wavelength less than or equal to 13.5 μm, less than or equal to 13 μm, less than or equal to 12 μm, less than or equal to 11 μm, or less than or equal to 10 μm. In some embodiments, the core region 150 disclosed herein may have a mode field diameter at 1550 nm wavelength greater than or equal to 9.5 μm and less than or equal to 13.5 μm—including all sub-ranges or values therebetween. For example, in some embodiments, the core region 150 disclosed herein may have a mode field diameter at 1550 nm wavelength greater than or equal to 10 μm and less than or equal to 13.5 μm, greater than or equal to 11 μm and less than or equal to 13.5 μm, greater than or equal to 12 μm and less than or equal to 13.5, greater than or equal to 13 μm and less than or equal to 13.5 μm, greater than or equal to 10 μm and less than or equal to 12.5 μm, greater than or equal to 11 μm and less than or equal to 12.5 μm, greater than or equal to 12 μm and less than or equal to 12.5, greater than or equal to 10 μm and less than or equal to 11.5 μm, greater than or equal to 11 μm and less than or equal to 11.5 μm, or greater than or equal to 10 μm and less than or equal to 10.5 μm.

In some embodiments, the core portion Cᵢ described herein may have a dispersion at 1550 nm of greater than or equal to 18 ps/nm/km and less than or equal to 22 ps/nm/km—including all sub-ranges and values there-between. For example, in some embodiments, the core portion Cᵢ described herein may have a dispersion at 1550 nm of greater than or equal to 18 ps/nm/km and less than or equal to 21 ps/nm/km, greater than or equal to 18 ps/nm/km and less than or equal to 20 ps/nm/km, greater than or equal to 18 ps/nm/km and less than or equal to 19 ps/nm/km, greater than or equal to 19 ps/nm/km and less than or equal to 22 ps/nm/km, greater than or equal to 19 ps/nm/km and less than or equal to 21 ps/nm/km, greater than or equal to 19 ps/nm/km and less than or equal to 20 ps/nm/km, greater than or equal to 20 ps/nm/km and less than or equal to 22 ps/nm/km, or greater than or equal to 20 ps/nm/km and less than or equal to 21 ps/nm/km.

In some embodiments, a co-propagating crosstalk at a wavelength of 1550 nm between two adjacent core portions may be less than or equal to −40 dB per 100 km of the multicore optical fiber 110, may be less than or equal to −45 dB per 100 km of the multicore optical fiber 110, or may be less than equal to −50 dB per 100 km of the multicore optical fiber 110. In some embodiments, a counter-propagating crosstalk at a wavelength of 1550 nm between two adjacent core portions may be less than or equal to −40 dB per 100 km of the multicore optical fiber 110, may be less than or equal to −45 dB per 100 km of the multicore optical fiber 110, or may be less than or equal to −50 dB per 100 km of the multicore optical fiber 110. In some embodiments, the counter-propagating crosstalk at a wavelength of 1550 nm between two adjacent core portions may be in the range from −40 dB to −100 dB per 100 km of the multicore optical fiber 110, from −45 dB to −100 dB per 100 km of the multicore optical fiber 110, from −50 dB to −100 dB per 100 km of the multicore optical fiber 110, or from −60 dB to −100 dB per 100 km of the multicore optical fiber 110.

As discussed above, the configuration of the multicore optical fiber 110 described herein may allow for transmission, such as counter-propagating transmission, at one or more wavelengths of C band (from 1535 nm to 1565 nm) and/or L band (from 1565 nm to 1625 nm) without inducing unacceptable level of crosstalk. In some embodiments, a counter-propagating crosstalk between two adjacent core portions at one or more wavelength in the C band and/or L band may be less than or equal to −40 dB per 100 km of the multicore optical fiber 110, may be less than or equal to −45 dB per 100 km of the multicore optical fiber 110, or may be less than or equal to −50 dB per 100 km of the multicore optical fiber 110. In some embodiments, the counter-propagating crosstalk between two adjacent core portions at one or more wavelength in the C band and/or L band may be in the range from −40 dB to −100 dB per 100 km of the multicore optical fiber 110, from −45 dB to −100 dB per 100 km of the multicore optical fiber 110, from −50 dB to −100 dB per 100 km of the multicore optical fiber 110, or from −60 dB to −100 dB per 100 km of the multicore optical fiber 110.

The average attenuation of the multicore optical fiber 110 is determined by measuring the attenuation for each core portion Cᵢ of the multicore optical fiber 110 at a wavelength of 1310 nm or 1550 nm and then calculating an average attenuation for the entire uncoupled-core multicore optical fiber 110 based on the individual attenuation measurements of each core portion Cᵢ. In some embodiments, the average attenuation at 1550 nm of the multicore optical fiber 110 may be less than 0.165 dB/km. In some embodiments, the average attenuation at 1550 nm of the multicore optical fiber 110 may be less than 0.16 dB/km. In some embodiments, the average attenuation at 1550 nm of the multicore optical fiber 110 may be less than 0.155 dB/km. In some embodiments, the average attenuation at 1550 nm of the multicore optical fiber 110 may be less than 0.15 dB/km. In some embodiments, the average attenuation at 1550 nm of the multicore optical fiber 110 may be in a range from about 0.13 dB/km to about 0.165 dB/km—including all sub-ranges and values there-between. For example, in some embodiments, the average attenuation at 1550 nm of the multicore optical fiber 110 may be in a range from about 0.13 dB/km to about 0.16 dB/km, from about 0.13 dB/km to about 0.155 dB/km, from about 0.13 dB/km to about 0.15 dB/km, from about 0.13 dB/km to about 0.145 dB/km, from about 0.13 dB/km to about 0.14 dB/km, from about 0.14 dB/km to about 0.165 dB/km, from about 0.14 dB/km to about 0.16 dB/km, from about 0.14 dB/km to about 0.155 dB/km, from about 0.14 dB/km to about 0.15 dB/km, from about 0.14 dB/km to about 0.145 dB/km, from about 0.145 dB/km to about 0.165 dB/km, from about 0.145 dB/km to about 0.16 dB/km, from about 0.145 dB/km to about 0.155 dB/km, from about 0.145 dB/km to about 0.15 dB/km, from about 0.15 dB/km to about 0.165 dB/km, from about 0.15 dB/km to about 0.16 dB/km, from about 0.15 dB/km to about 0.155 dB/km, or from about 0.155 dB/km to about 0.16 dB/km.

The individual attenuation of each core portion Cᵢ at 1550 nm may be less than 0.165 dB/km. In some embodiments, the individual attenuation of each core portion Cᵢ at 1550 nm may be less than 0.16 dB/km. In some embodiments, the individual attenuation of each core portion Cᵢ at 1550 nm may be less than 0.155 dB/km. In some embodiments, the individual attenuation of each core portion Cᵢ at 1550 nm may be less than 0.15 dB/km. In some embodiments, the individual attenuation of each core portion Cᵢ at 1550 nm may be in a range from about 0.13 dB/km to about 0.165 dB/km—including all sub-ranges and values there-between. For example, in some embodiments, the individual attenuation of each core portion Cᵢ at 1550 nm may be in a range from about 0.13 dB/km to about 0.16 dB/km, from about 0.13 dB/km to about 0.155 dB/km, from about 0.13 dB/km to about 0.15 dB/km, from about 0.13 dB/km to about 0.145 dB/km, from about 0.13 dB/km to about 0.14 dB/km, from about 0.14 dB/km to about 0.165 dB/km, from about 0.14 dB/km to about 0.16 dB/km, from about 0.14 dB/km to about 0.155 dB/km, from about 0.14 dB/km to about 0.15 dB/km, from about 0.14 dB/km to about 0.145 dB/km, from about 0.145 dB/km to about 0.165 dB/km, from about 0.145 dB/km to about 0.16 dB/km, from about 0.145 dB/km to about 0.155 dB/km, from about 0.145 dB/km to about 0.15 dB/km, from about 0.15 dB/km to about 0.165 dB/km, from about 0.15 dB/km to about 0.16 dB/km, from about 0.15 dB/km to about 0.155 dB/km, from about 0.155 dB/km to about 0.165 dB/km, or from about 0.155 dB/km to about 0.16 dB/km.

As discussed above, the configuration of the multicore optical fiber 110 described herein may allow for transmission at one or more wavelengths of C band (from 1535 nm to 1565 nm) and/or L band (from 1565 nm to 1625 nm) without inducing unacceptable level of attenuation. In some embodiments, the individual attenuation of each core portion Cᵢ or the average attenuation thereof at one or more wavelength in the C band and/or L band may be less than 0.165 dB/km. In some embodiments, the individual attenuation of each core portion Cᵢ or the average thereof at one or more wavelength in the C band and/or L band may be less than 0.16 dB/km. In some embodiments, the individual attenuation of each core portion Cᵢ or the average thereof at one or more wavelength in the C band and/or L band may be less than 0.155 dB/km. In some embodiments, the individual attenuation of each core portion Cᵢ or the average thereof at one or more wavelength in the C band and/or L band may be less than 0.15 dB/km. In some embodiments, the individual attenuation of each core portion Cᵢ or the average thereof at one or more wavelength in the C band and/or L band may be in a range from about 0.13 dB/km to about 0.165 dB/km—including all sub-ranges and values there-between. For example, in some embodiments, the individual attenuation of each core portion Cᵢ or the average thereof at one or more wavelength in the C band and/or L band may be in a range from about 0.13 dB/km to about 0.16 dB/km, from about 0.13 dB/km to about 0.155 dB/km, from about 0.13 dB/km to about 0.15 dB/km, from about 0.13 dB/km to about 0.145 dB/km, from about 0.13 dB/km to about 0.14 dB/km, from about 0.14 dB/km to about 0.165 dB/km, from about 0.14 dB/km to about 0.16 dB/km, from about 0.14 dB/km to about 0.155 dB/km, from about 0.14 dB/km to about 0.15 dB/km, from about 0.14 dB/km to about 0.145 dB/km, from about 0.145 dB/km to about 0.165 dB/km, from about 0.145 dB/km to about 0.16 dB/km, from about 0.145 dB/km to about 0.155 dB/km, from about 0.145 dB/km to about 0.15 dB/km, from about 0.15 dB/km to about 0.165 dB/km, from about 0.15 dB/km to about 0.16 dB/km, or from about 0.155 dB/km to about 0.165 dB/km.

The radiation loss, as discussed herein, represents mode leakage loss that may be due to a smaller core edge to glass fiber edge distance and overlap of mode field intensity with high index primary coating. Methods for determining radiation loss can be found in P. Tandon, et al., “Impact of multicore fiber (MCF) opticals, cross-talk, radiative leakage loss, splice loss and propagation configuration on the system transmission performance,” Optics Communications, Volume 539, 15 Jul. 2023, 129483, and P. Tandon, et al., “Record Low Loss 0.144 dB/km 2-Core Optical Fiber for Submarine Transmission,” Journal of Lightwave Technology, Vol. 42, No. 12, Jun. 15, 2024, J. Hu, et al., “Understanding leaky modes: slab waveguide revisited,” Adv. Opt. Photonics 1 (2009) 58-106, the contents of which are all incorporated herein by reference in their entirety. In some embodiments, the radiation loss of each core portion Cᵢ may be less than about 0.01 dB/km at a wavelength of 1550 nm, less than about 0.009 dB/km at a wavelength of 1550 nm, less than about 0.007 dB/km at a wavelength of 1550 nm, less than about 0.005 dB/km at a wavelength of 1550 nm, or less than about 0.003 dB/km at a wavelength of 1550 nm. In some embodiments, the radiation loss of each core portion Cᵢ may be in the range from 0.0001 dB/km to 0.01 dB/km at a wavelength of 1550 nm, from 0.0001 dB/km to 0.009 dB/km at a wavelength of 1550 nm, from 0.0001 dB/km to 0.007 dB/km at a wavelength of 1550 nm, from 0.0001 dB/km to 0.005 dB/km at a wavelength of 1550 nm, or from 0.0001 dB/km to 0.003 dB/km at a wavelength of 1550 nm.

As discussed above, the configuration of the multicore optical fiber 110 described herein may allow for transmission at one or more wavelengths of C band (from 1535 nm to 1565 nm) and/or L band (from 1565 nm to 1625 nm) without inducing unacceptable level of radiation loss. In some embodiments, the radiation loss of each core portion Cᵢ at one or more wavelengths in the C band and/or L band may be less than about 0.01 dB/km, less than about 0.009 dB/km, less than about 0.007 dB/km, less than about 0.005 dB/km, or less than about 0.003 dB/km. In some embodiments, the radiation loss of each core portion Cᵢ at one or more wavelengths in the C band and/or L band may be in the range from 0.0001 dB/km to 0.01 dB/km, from 0.0001 dB/km to 0.009 dB/km, from 0.0001 dB/km to 0.007 dB/km, from 0.0001 dB/km to 0.005 dB/km, or from 0.0001 dB/km to 0.003 dB/km.

The uncoupled-core multicore optical fibers of the present disclosure can be made using any suitable method for forming a multicore optical fiber. See, for example, U.S. Pat. No. 11,370,689 B2, the entire content of which is incorporated herein by reference. An exemplary method that is used to form the multicore optical fiber (or any of the alternative embodiments thereof) described herein includes forming a glass blank for common cladding. Formation of the glass blank may involve first forming a soot body via an outside vapor deposition (“OVD”) process, a soot pressing method, a vapor axial deposition (“VAD”) process, or any other known method and then dehydrated and consolidated to fully densified glass. The soot body may be formed of a glass precursor material. In some embodiments, the soot body is formed of silica-based material. Multiple holes are then drilled along the length of the glass blanks for the core canes to be inserted in them. In some embodiments, the common cladding glass blank is doped with a down dopant such as fluorine.

Next, a core region of a core cane may be formed. In some embodiments, the core region is comprised of at least one alkali in concentration between 0.1 wt % and 5 wt %. In some embodiments, the core is doped with potassium. In other embodiments, the core is doped with two alkali components selected from the group comprising potassium, sodium, rubidium, and cesium. The core cane may be formed by methods disclosed in U.S. Pat. No. 7,536,076 B2, the entire content of which is incorporated herein by reference.

Next, one or more clad layers may be deposited on the core region. In some embodiments, soot overclad layer(s) of silica-based soot is formed on the core region via an OVD or VAD process. The overclad layer(s) has a composition corresponding to the depressed-index cladding of the core portion of the multicore optical fiber. For example, the overlayers may include separate layers having a composition corresponding to trench region. The overcladded core region is positioned within a consolidation furnace and consolidation of the overcladded core region is initiated. For example, the overcladded core region may be heated to a peak sintering temperature to initiate consolidation.

During the consolidation, the overcladded core region is exposed to a down-dopant for a period T after initiation of the consolidation. A soot preform resulting from the completion of the consolidation process includes a core region and an overcladding layer surrounding the core region. The core region (e.g., in an unconsolidated or partially consolidated state) and overcladding layer may be placed in an interior of a consolidation furnace. The consolidation furnace may be heated to a peak sintering temperature of the overcladding layer to initiate consolidation.

A gas source is in fluid communication with the interior of the consolidation furnace provides a gas containing a down-dopant into the interior. The down-dopant (e.g., fluorine) then diffuses through the overcladding layer during consolidation. In some embodiments, the rate of diffusion of the down-dopant through the overcladding layer is dependent on the compositional and material properties of the overcladding layer (e.g., porosity, density, etc.). As the overcladding layer is consolidated, the porosity of the overcladding layer is diminished such that a rate of diffusion of the down-dopant may decrease as the overcladding layer consolidates.

In some embodiments, a region of the core portion encircling and directly contacting the core corresponds to the trench region. In some embodiments, trench region possess a concentration of the down-dopant.

After the core region is consolidated into a glass preform, the glass preform is inserted into the holes drilled into the glass blank formed during the step. After each core cane is inserted into the glass blank, the fiber preform is assembled by thermally closing the gap between the inserted cane and the drilled hole. The assembled preform is then drawn into a multicore optical fiber. The multicore optical fiber may then be coated with one or more coatings, such as a primary coating, a secondary coating, etc. Example methods of forming a cane-based optical fiber preform are discussed in U.S. Pat. No. 11,370,689, the entire content of which is incorporated by reference herein. Example coating materials and methods are discussed in U.S. Pat. No. 9,057,817, the entire content of which is incorporated by reference herein.

### Examples

Provided below are exemplary embodiments of the multicore optical fibers disclosed herein. The below exemplary embodiments are intended to be exemplary and are not intended to limit the scope of the disclosure.

Table 1 below provides three exemplary core portion designs (Design A, Design B, and Design C) of the multicore optical fibers according to some embodiments described herein. Design A has a relative refractive index profile similar to that depicted in FIG. 4, Design B has a relative refractive index profile similar to that depicted in FIG. 7, and Design C has a relative refractive index profile similar to that depicted in FIG. 5.

TABLE 1

| | Design A | Design B | Design C |
|---|---|---|---|
| Core Region Refractive | 0 | 0 | 0 |
| Index (Δ₁%) | | | |
| Core Radius r₁ (μm) | 5.55 | 6.1 | 4.67 |
| Core Alpha | 20 | 20 | 20 |
| Inner Cladding Refractive | −0.245 | — | −0.34 |
| Index (Δ₂%) | | | |
| Inner Cladding Region | 10 | — | 10 |
| Radius r₂ (μm) | | | |
| Trench Region Refractive | −0.555 | −0.33 | −0.61 |
| Index, Δ₃% | | | |
| Trench Region Radius, | 16.5 | 16.5 | 17.63 |
| r₃ (μm) | | | |
| Trench Volume (%Δ μm²) | _−53.4_ | −20 | _{——}−56.9 |
| Common Cladding | −0.245 | −0.245 | −0.34 |
| Refractive Index (Δ₄%) | | | |
| Cable Cutoff (nm) | 1386 | 1423 | 1383 |
| Effective Area A_{eff} at | 110.39 | 110.23 | 82.53 |
| 1550 nm (μm²) | | | |
| Dispersion at 1550 nm | 21.056 | 20.9 | 19.09 |
| (ps/nm/km) | | | |
| Dispersion Slope at | 6.43E−02 | 6.09E−02 | 6.27E−02 |
| 1550 nm (ps/nm²/km) | | | |

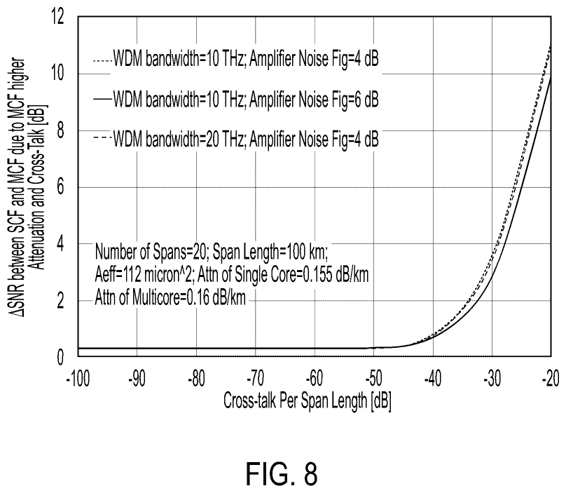

FIG. 8 illustrates the impact of crosstalk on the SNR performance of bidirectional (or counterpropagating) transmission system, based on calculation as further described in P. Tandon, et al., “Record Low Loss 0.144 dB/km 2-Core Optical Fiber for Submarine Transmission,” Journal of Lightwave Technology, Vol. 42, No. 12, Jun. 15, 2024, P. Tandon, et al., “Impact of multicore fiber (MCF) optical, cross-talk, radiative leakage loss, splice loss and propagation configuration on the system transmission performance,” Opt. Commun., vol. 539, July 2023, Art. no. 129483, doi: 10.1016/j.optcom.2023.129483, M. Ohashi, et al., “Optical fibers for space-division multiplexing,” in Space Division Multiplexing in Optical Communication Systems, M. Nakazawa, et al., Eds. Cham, Switzerland: Springer, 2022, Ch. 2, pp. 40-170, T. Hayashi, et al., “Uncoupled multi-core fiber enhancing signal-to-noise ratio,” Opt. Exp., vol. 20, pp. B94-B103, 2012, J. M. Gene and P. J. Winzer, “A universal specification for multicore Fiber crosstalk,” IEEE Photon. Technol. Lett., vol. 31, no. 9, pp. 673-676, May 2019, T. Hayashi, et al., “Low loss multi-core fibers for submarine transmission,” in Proc. SubOptic, 2019, Paper OP10-3, the contents of which are all incorporated herein by reference in their entirety.

In FIG. 8, the sensitivity of transmission system SNR or ΔSNR between single-core fiber (SCF) and multicore optical fiber (MCF) on crosstalk was calculated for: number of spans=20, span length=100 km, WDM bandwidth=20 THz, and amplifier noise figure=4-6 dB. It has been observed that SNR may be negatively impacted when crosstalk between adjacent core portions becomes greater than about −45 dB/100 km (or about −65 dB/km).

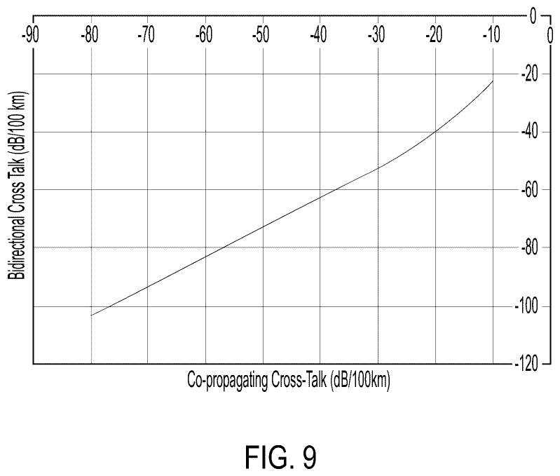

FIG. 9 illustrates the calculated inter-core crosstalk for co-propagating transmission and inter-core crosstalk for counter-propagating transmission per 100 km for multicore optical fibers having an effective area A_{eff} of 112 μm². It has been observed that utilizing the multicore optical fibers described herein for bidirectional (or counterpropagating) transmission may reduce crosstalk appreciably when compared to co-propagating mode of transmission, thereby allowing a greater number of core portions to be accommodated in the multicore optical fiber to achieve increased transmission capacity. Details of crosstalk calculations can be found in P. Tandon, et al., “Record Low Loss 0.144 dB/km 2-Core Optical Fiber for Submarine Transmission,” Journal of Lightwave Technology, Vol. 42, No. 12, Jun. 15, 2024, M. Koshiba, et al., “Analytical expression of average power-coupling coefficients for estimating intercore CrossTalk in multicore fibers,” IEEE Photon. J, vol. 4, no. 50, pp. 1987-1995, October 2012, F. Ye, et al., “Simple analytical expression for crosstalk estimation in homogeneous trench-assisted multi-core fibers,” Opt. Exp., vol. 22, no. 19, pp. 23007-23018, 2014, T. Hayashi, et al., “Design and fabrication of ultra-low crosstalk and low-loss multi-core fiber,” Opt. Exp., vol. 19, pp. 16576-16592, 2011, T. Hayashi, et al., “Uncoupled multi-core fiber design for practical bidirectional optical communications,” in Proc. Opt. Fiber Commun. Conf, 2022, Paper M1E.1, and A. Sano, et al., “Crosstalk-managed high capacity long haul multicore Fiber transmission with propagation direction interleaving,” J. Lightw. Technol., vol. 32, no. 16, pp. 2771-2779, August 2014, the contents of which are all incorporated herein by reference in their entirety.

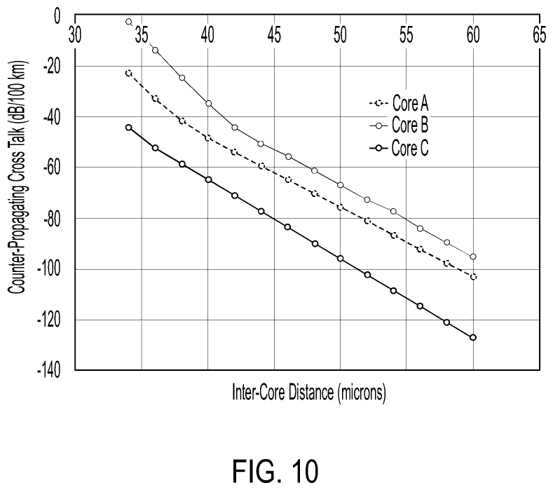

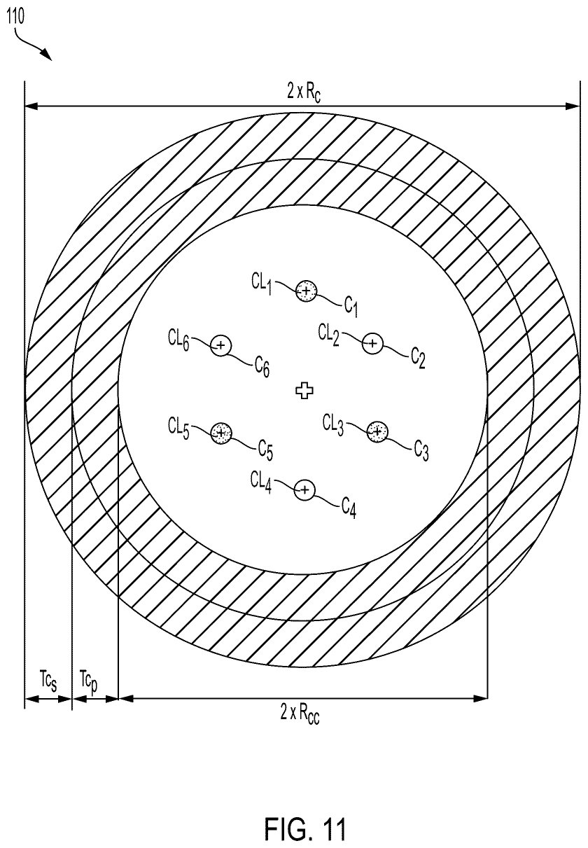

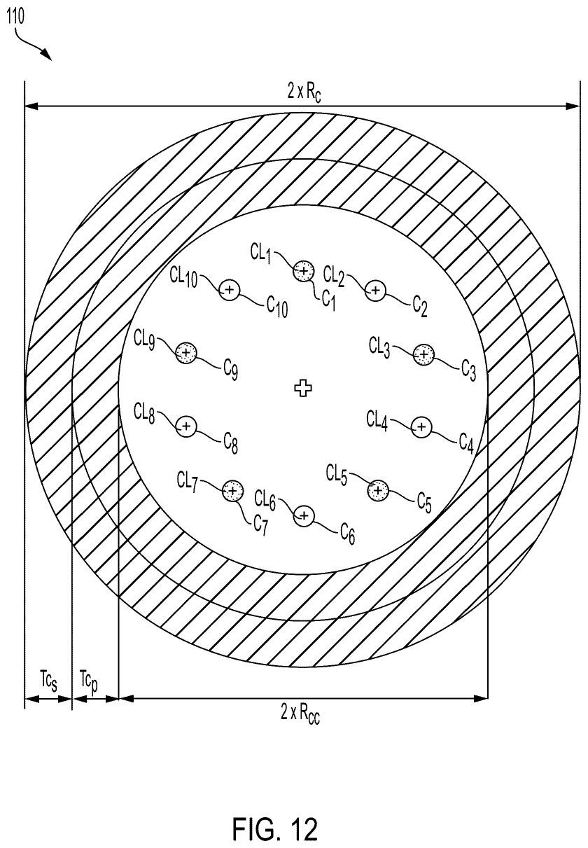

FIG. 10 illustrates the calculated counter-propagating crosstalk for core portion Designs A, B, and C of Table 1. Without intending to be bound by any particular theory, to achieve low crosstalk between adjacent core portions, the core-to-core separation distance may need to be greater than a certain distance for the core portions to be uncoupled. However, increasing the core-to-core separation distance to help with reducing the crosstalk may position the core portions closer to the outer radius of the glass fiber, which may lead to increased attenuation due to radiation leakage loss from overlap of mode field with the high refractive index coating. To minimize radiation leakage loss while also maintaining low crosstalk between adjacent core portions, the inventors have designed the multicore optical fibers described herein. Table 2 below provides six exemplary multicore optical fiber designs (Examples 1-6) utilizing various core designs in accordance with some embodiments described herein. Examples 1, 3, and 5 each have a core arrangement similar to that shown in FIG. 2, Examples 2 and 4 each have a core arrangement similar to that shown in FIG. 11, and Example 6 has a core arrangement similar to that shown in FIG. 12. In the examples shown in FIGS. 11 and 12, the core portions are arranged annularly about the central fiber axis, and the core portions in the respective examples are positioned at an equal radial distance from the central fiber axis.

TABLE 2

| | Ex 1 | Ex 2 | Ex 3 | Ex 4 | Ex 5 | Ex 6 |
|---|---|---|---|---|---|---|
| Core Design | Design A | Design A | Design B | Design B | Design C | Design C |
| Number of Cores | 8 | 6 | 8 | 6 | 8 | 10 |
| Inter-Core Distance (μm) | 36 | 36 | 40 | 40 | 33 | 33 |
| Circumradius (μm) | 47 | 36 | 52 | 40 | 43 | 53 |
| Glass Fiber Radius (μm) | 84 | 73 | 89 | 78 | 80 | 90 |
| Glass Fiber Diameter (μm) | 168 | 146 | 178 | 156 | 160 | 180 |
| Coating Diameter (μm) | 250 | 250 | 250 | 250 | 250 | 250 |
| Effective Area (μm²) | 110 | 110 | 110 | 110 | 82 | 82 |
| Number of Cores per | 0.000361 | 0.000358 | 0.000321 | 0.000314 | 0.000398 | 0.000393 |
| Glass Fiber Area* (μm⁻²) | | | | | | |
| Core Multiplicity Factor | 0.039699 | 0.039423 | 0.035363 | 0.034531 | 0.032627 | 0.032224 |

*Number of Cores per Glass Fiber Area = Number of Cores/(π × Glass Fiber Radius²)

As shown in Table 2 above, the various designs of the multicore optical fibers described herein, in particular the CMF values described herein, may allow for a large number of core portions to be accommodated within a multicore optical fiber with standard form factors, such as standard coating diameter, thereby enabling the processing/incorporation of the multicore optical fibers described herein in existing cables while achieving increased transmission capacity, low crosstalk, low attenuation, low radiation loss, etc.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

### EXEMPLARY CLAIM SET

Exemplary claim 1. An uncoupled multicore optical fiber for counter-propagation transmission, comprising:
a common cladding having a refractive index Δ_{CC} and an outer radius R_{CC} greater than or equal to 70 μm and less than or equal to 95 μm;
a coating encircling and directly contacting the common cladding and extending from the outer radius R_{CC} to an outer radius R_{C} that is greater than or equal to 120 μm and less than or equal to 127.5 μm; and
a plurality of core portions disposed within the common cladding;
wherein at least one core portion of the plurality of core portions comprises:
   a central axis;
   a core region extending from the central axis, the core region comprising a relative refractive index Δ₁ relative to pure silica, wherein the core region comprises an alkali dopant;
   a trench region encircling the core region, the trench region comprising a relative refractive index Δ₃ relative to pure silica, wherein Δ₁>Δ_{CC}>Δ₃;
   an attenuation of less than 0.16 dB/km at a wavelength of 1550 nm;
   an effective area greater than or equal to 75 μm² and less than or equal to 135 μm² at a wavelength of 1550 nm; and
   a cable cutoff wavelength less than or equal to 1530 nm;
wherein the common cladding directly contacts the trench region;
wherein the uncoupled multicore optical fiber has a core multiplicity factor ranging from about 0.028 to about 0.045; and
wherein a counter-propagating crosstalk between two adjacent core portions is less than or equal to −40 dB per 100 km of the uncoupled multicore optical fiber.

Exemplary claim 2. The uncoupled multicore optical fiber of exemplary claim 1, wherein the coating comprises:
a primary coating encircling and directly contacting the common cladding; and
a secondary coating encircling and directly contacting the primary coating.

Exemplary claim 3. The uncoupled multicore optical fiber of exemplary claim 2, wherein an outer radius R_{Cs} of the secondary coating is greater than or equal to 120 μm and less than or equal to 127.5 μm.

Exemplary claim 4. The uncoupled multicore optical fiber of any of exemplary claims 1 to 3, wherein an outer radius R_{Cp} of the primary coating is greater than or equal to 170 μm and less than or equal to 220 μm.

Exemplary claim 5. The uncoupled multicore optical fiber of any of exemplary claims 1 to 4, wherein each core portion of the plurality of core portions comprises:
a central axis;
a core region extending from the central axis, the core region comprising a relative refractive index Δ₁ relative to pure silica, wherein the core region comprises an alkali dopant;
a trench region encircling the core region, the trench region comprising a relative refractive index Δ₃ relative to pure silica, wherein Δ₁>Δ_{CC}>Δ₃;
an attenuation of less than 0.16 dB/km at a wavelength of 1550 nm;
a radiation loss of less than 0.01 dB/km at a wavelength of 1550 nm;
an effective area greater than or equal to 75 μm² and less than or equal to 135 μm² at a wavelength of 1550 nm; and
a cable cutoff wavelength less than or equal to 1530 nm.

Exemplary claim 6. An uncoupled multicore optical fiber for counter-propagation transmission, comprising:
a common cladding having a refractive index Δ_{CC} and an outer radius R_{CC} greater than or equal to 70 μm and less than or equal to 95 μm;
a coating comprises:
   a primary coating encircling and directly contacting the common cladding and extending from the outer radius R_{CC} to an outer radius R_{Cp}; and
   a secondary coating encircling and directly contacting the primary coating and extending from the outer radius R_{Cp} to an outer radius R_{Cs}, wherein the outer radius R_{Cs} is greater than or equal to 120 μm and less than or equal to 127.5 μm; and
a plurality of core portions disposed within the common cladding, wherein at least one core portion of the plurality of core portions comprises:
   a central axis;
   a core region extending from the central axis, the core region comprising a relative refractive index Δ₁ relative to pure silica, wherein the core region comprises an alkali dopant;
   a trench region encircling the core region, the trench region comprising a relative refractive index Δ₃ relative to pure silica, wherein the common cladding directly contacts the trench region, and wherein Δ₁>Δ_{CC}>Δ₃;
   an attenuation of less than 0.16 dB/km at a wavelength of 1550 nm;
   an effective area greater than or equal to 75 μm² and less than or equal to 135 μm² at a wavelength of 1550 nm; and
   a cable cutoff wavelength less than or equal to 1530 nm;
wherein the uncoupled multicore optical fiber has a core multiplicity factor ranging from about 0.028 to about 0.045; and
wherein a counter-propagating crosstalk between two adjacent core portions is less than or equal to −40 dB per 100 km of the uncoupled multicore optical fiber.

Exemplary claim 7. The uncoupled multicore optical fiber of any one of exemplary claims 5 to 6, wherein the at least one core portion of the plurality of core portions further comprises:
an inner-cladding region between the core region and the trench region, the inner cladding region comprising a relative refractive index Δ₂ relative to pure silica.

Exemplary claim 8. The uncoupled multicore optical fiber of exemplary claim 7, wherein:
the core region extends from the central axis to an outer radius r₁;
the inner-cladding region encircles and directly contacts the core region and extends from the outer radius r₁ to an outer radius r₂; and
the trench region encircles and directly contacts the inner-cladding region and extends from the outer radius r₂ to an outer radius r₃, wherein the common cladding directly contacts the trench region and extends from the outer radius r₃ to the outer radius R_{CC}.

Exemplary claim 9. The uncoupled multicore optical fiber of exemplary claim 8, wherein an outer radius r₁ of the core region is greater than or equal to 3.5 μm and less than or equal to 6 μm.

Exemplary claim 10. The uncoupled multicore optical fiber of any one of exemplary claims 8 to 9, wherein an outer radius r₂ of the inner-cladding region is greater than or equal to 6 μm and less than or equal to 14 μm.

Exemplary claim 11. The uncoupled multicore optical fiber of any one of exemplary claims 8 to 10, wherein an outer radius r₃ of the trench region is greater than or equal to 7 μm and less than or equal to 20 μm.

Exemplary claim 12. The uncoupled multicore optical fiber of any of exemplary claims 8 to 11, wherein the relative refractive index Δ₃ of the trench region remains substantially constant from the outer radius r₂ to the outer radius r₃ such that the trench region has a substantially rectangular shape.

Exemplary claim 13. The uncoupled multicore optical fiber of any of exemplary claims 7 to 12, wherein the refractive index Δ₂ of the inner cladding region is in the range of about −0.2%Δ to −0.3%Δ.

Exemplary claim 14. The uncoupled multicore optical fiber of any of exemplary claims 7 to 13, wherein Δ₁>Δ₂>Δ₃.

Exemplary claim 15. The uncoupled multicore optical fiber of any of exemplary claims 7 to 13, wherein Δ₁>Δ₂=Δ₃.

Exemplary claim 16. The uncoupled multicore optical fiber of any one of exemplary claims 3 to 15, wherein the outer radius R_{Cs} of the secondary coating is greater than or equal to 124 μm and less than or equal to 126 μm.

Exemplary claim 17. The uncoupled multicore optical fiber of any one of exemplary claims 2 to 16, wherein a ratio of a thickness of the secondary coating to a thickness of the primary coating ranges from about 0.7 to about 1.3, or from about 0.8 to about 1.2.

Exemplary claim 18. The uncoupled multicore optical fiber of any one of exemplary claims 2 to 17, wherein at least one of a thickness of the primary coating or a thickness of the secondary coating is greater than or equal to 14 μm and less than or equal to 35 μm.

Exemplary claim 19. The uncoupled multicore optical fiber of any one of exemplary claims 2 to 18, wherein the in-situ modulus of the primary coating is greater than or equal to 0.15 MPa and less than or equal to 0.4 MPa.

Exemplary claim 20. The uncoupled multicore optical fiber of any one of exemplary claims 2 to 19, wherein the in-situ modulus of the secondary coating is greater than or equal to 1,600 MPa and less than or equal to 2,400 MPa.

Exemplary claim 21. The uncoupled multicore optical fiber of any one of exemplary claims 1 to 20, wherein the outer radius R_{CC} is greater than or equal to 70 μm and less than or equal to 90 μm, or greater than or equal to 75 μm and less than or equal to 90 μm.

Exemplary claim 22. The uncoupled multicore optical fiber of any one of exemplary claims 1 to 21, wherein the plurality of core portions comprises at least 6 core portions, or 6 to 10 core portions, or 6 to 8 core portions.

Exemplary claim 23. The uncoupled multicore optical fiber of any one of exemplary claims 1 to 22, wherein the alkali dopant comprises at least one of sodium, potassium, rubidium, and lithium.

Exemplary claim 24. The uncoupled multicore optical fiber of any of exemplary claims 1 to 23, wherein an average concentration of the alkali dopant in the core portion is greater than or equal to 10 ppm or greater than or equal to 20 ppm and less than or equal to 500 ppm.

Exemplary claim 25. The uncoupled multicore optical fiber of any one of exemplary claims 1 to 25, wherein the refractive index Δ₁ of the core region is in the range of about −0.05%Δ to about 0.05%Δ.

Exemplary claim 26. The uncoupled multicore optical fiber of any one of exemplary claims 1 to 25, wherein the refractive index Δ₃ of the trench region is in the range of about −0.25%Δ to about −0.7%Δ.

Exemplary claim 27. The uncoupled multicore optical fiber of any one of exemplary claims 1 to 26, wherein the refractive index Δ_{CC} of the common cladding is in the range of about −0.2%Δ to about −0.4%Δ.

Exemplary claim 28. The uncoupled multicore optical fiber of any of exemplary claims 1 to 27, wherein the trench region has a trench volume greater than or equal to 5%Δ micron² and less than or equal to 60%Δ micron².

Exemplary claim 29. The uncoupled multicore optical fiber of any one of exemplary claims 1 to 20, wherein the cable cutoff wavelength of the at least one core portion of the plurality of core portions is greater than or equal to 1300 nm.

Exemplary claim 30. The uncoupled multicore optical fiber of any one of exemplary claims 1 to 29, wherein the effective area of the at least one core portion of the plurality of core portions is greater than or equal to 100 μm² and less than or equal to 125 μm² at a wavelength of 1550 nm.

Exemplary claim 31. The uncoupled multicore optical fiber of any one of exemplary claims 1 to 30, wherein a co-propagating crosstalk between two adjacent core portions is less than or equal to −50 dB per 100 km of the uncoupled multicore optical fiber.

Exemplary claim 32. The uncoupled multicore optical fiber of any one of exemplary claims 1 to 31, wherein a counter-propagating crosstalk between two adjacent core portions is less than or equal to −50 dB per 100 km of the uncoupled multicore optical fiber.

Exemplary claim 33. The uncoupled multicore optical fiber of any one of exemplary claims 1 to 32, wherein the dispersion at 1550 nm of the at least one core portion of the plurality of core portions is greater than or equal to 18 ps/nm/km and less than or equal to 22 ps/nm/km.

Exemplary claim 34. The uncoupled multicore optical fiber of any one of exemplary claims 1 to 33, wherein the uncoupled multicore optical fiber is configured for transmission over at least one of C band or L band or over one or more wavelengths between 1535 nm and 1625 nm.

Exemplary claim 35. The uncoupled multicore optical fiber of any one of exemplary claims 1 to 34, wherein central axes of adjacent core portions of the plurality of core portions are separated from one another by a minimum separation distance that is greater than or equal to 32 μm and less than or equal to 50 μm, or greater than or equal to 34 μm and less than or equal to 45 μm, or greater than or equal to 34 μm and less than or equal to 40 μm.

Exemplary claim 36. A bidirectional transmission system, comprising an uncoupled multicore optical fiber of any one of exemplary claims 1 to 13.

Exemplary claim 37. The bidirectional transmission system of exemplary claim 36, further comprising:
a first transceiver optically coupled to a first end of the uncoupled multicore optical fiber; and
a second transceiver optically coupled to a second end of the uncoupled multicore optical fiber opposite the first end of the uncoupled multicore optical fiber;
wherein the first transceiver and the second transceiver are configured to transmit signals from the first end of the uncoupled multicore optical fiber to the second end of the uncoupled multicore optical fiber via a first plurality of core portions of the uncoupled multicore optical fiber; and
wherein the first transceiver and the second transceiver are further configured to transmit signals from the second end of the uncoupled multicore optical fiber to the first end of the uncoupled multicore optical fiber via a second plurality of core portions of the uncoupled multicore optical fiber.

Exemplary claim 38. The bidirectional transmission system of exemplary claim 37, wherein the first plurality of core portions of the uncoupled multicore optical fiber is different from the second plurality of core portions of the uncoupled multicore optical fiber.

Exemplary claim 39. The bidirectional transmission system of any one of exemplary claims 37 to 38, wherein:
the first transceiver comprises:
   a first plurality of light sources optically coupled to the first plurality of core portions of the uncoupled multicore optical fiber; and
   a first plurality of detectors optically coupled to the second plurality of core portions of the uncoupled multicore optical fiber; and
the second transceiver comprises:
   a second plurality of light sources optically coupled to the second plurality of core portions of the uncoupled multicore optical fiber; and
   a second plurality of detectors optically coupled to the first plurality of core portions of the uncoupled multicore optical fiber.

Exemplary claim 40. A method of bidirectional transmission over a multicore optical fiber having a first plurality of core portions and a second plurality of core portions, the method comprising:
transmitting a first optical signal over at least one core portion of the first plurality of core portions in a first direction, wherein the at least one core portion of the first plurality of core portions comprises:
   a core region comprising an alkali dopant; and
   an attenuation of less than 0.16 dB/km at a wavelength of 1550 nm;
transmitting a second optical signal over at least one core portion of the second plurality of core portions in a second direction opposite the first direction, wherein the at least one core portion of the second plurality of core portions comprises:
   a core region comprising an alkali dopant; and
   an attenuation of less than 0.16 dB/km at a wavelength of 1550 nm;
wherein the first plurality of core portions and the second plurality of core portions are disposed within a common cladding having an outer radius R_{CC} greater than or equal to 70 μm and less than or equal to 95 μm;
wherein the multicore optical fiber further comprises a coating encircling and directly contacting the common cladding, wherein an outer radius R_{C} of the coating is greater than or equal to 120 μm and less than or equal to 127.5 μm;
wherein the multicore optical fiber has a core multiplicity factor ranging from about 0.028 to about 0.045; and
wherein a counter-propagating crosstalk between two adjacent core portions is less than or equal to −40 dB per 100 km of the uncoupled multicore optical fiber.

Exemplary claim 41. The method of exemplary claim 40, wherein the outer radius R_{C} of the coating is greater than or equal to 120 μm and less than or equal to 127.5 μm, or greater than or equal to 124 μm and less than or equal to 126 μm.

Exemplary claim 42. The method of any of exemplary claims 40 to 41, wherein the coating comprises:
a primary coating encircling and directly contacting the common cladding; and
a secondary coating encircling and directly contacting the primary coating.

Exemplary claim 43. The method of exemplary claim 42, wherein an outer radius R_{Cs} of the secondary coating is greater than or equal to 120 μm and less than or equal to 127.5 μm, or greater than or equal to 124 μm and less than or equal to 126 μm.

Exemplary claim 44. The method of any of exemplary claims 42 to 43, wherein an outer radius R_{Cp} of the primary coating is greater than or equal to 170 μm and less than or equal to 220 μm.

Exemplary claim 45. The method of any of exemplary claims 42 to 44, wherein a ratio of a thickness of the secondary coating to a thickness of the primary coating ranges from about 0.7 to about 1.3, or from about 0.8 to about 1.2.

Exemplary claim 46. The method of any of exemplary claims 42 to 45, wherein at least one of a thickness of the primary coating or a thickness of the secondary coating is greater than or equal to 14 μm and less than or equal to 35 μm.

Exemplary claim 47. The method of any of exemplary claims 42 to 46, wherein the in-situ modulus of the primary coating is greater than or equal to 0.15 MPa and less than or equal to 0.4 MPa.

Exemplary claim 48. The method of any of exemplary claims 42 to 47, wherein the in-situ modulus of the secondary coating is greater than or equal to 1,600 MPa and less than or equal to 2,400 MPa.

Exemplary claim 49. The method of any of exemplary claims 40 to 48, wherein each core portion of the first plurality of core portions comprises at least one of:
a core region comprising an alkali dopant;
an attenuation of less than 0.16 dB/km at a wavelength of 1550 nm;
a radiation loss of less than 0.01 dB/km at a wavelength of 1550 nm; or
an effective area that is greater than or equal to 75 μm² and less than or equal to 135 μm² at a wavelength of 1550 nm, or greater than or equal to 100 μm² and less than or equal to 125 μm² at a wavelength of 1550 nm.

Exemplary claim 50. The method of any one of exemplary claims 40 to 49, wherein each core portion of the second plurality of core portions comprises at least one of:
a core region comprising an alkali dopant;
an attenuation of less than 0.16 dB/km at a wavelength of 1550 nm;
a radiation loss of less than 0.01 dB/km at a wavelength of 1550 nm; or an effective area that is greater than or equal to 75 μm² and less than or equal to 135 μm² at a wavelength of 1550 nm, or greater than or equal to 100 μm² and less than or equal to 125 μm² at a wavelength of 1550 nm.

Exemplary claim 51. The method of any of exemplary claims 40 to 50, wherein each core portion of the first plurality of core portions and the second plurality of core portions further comprises:
an inner-cladding region encircling and directly contacting the core region; and
a trench region encircling and directly contacting the inner cladding region, wherein the common cladding directly contacts the trench region.

Exemplary claim 52. The method of exemplary claim 51, wherein the trench region has a trench volume greater than or equal to 5%Δ micron² and less than or equal to 60% Δmicron².

Exemplary claim 53. The method of any one of exemplary claims 51 to 52, wherein the core region comprising a relative refractive index Δ₁ relative to pure silica, wherein the inner cladding region comprising a relative refractive index Δ₂ relative to pure silica, wherein the trench region comprising a relative refractive index Δ₃ relative to pure silica, and wherein Δ₁>Δ₂≥Δ₃.

Exemplary claim 54. The method of any one of exemplary claims 51 to 52, wherein the core region comprising a relative refractive index Δ₁ relative to pure silica, wherein the trench region comprising a relative refractive index Δ₃ relative to pure silica, wherein the common cladding has a refractive index Δ_{CC}, and wherein Δ₁>Δ_{CC}>Δ₃.

Exemplary claim 55. The method of any one of exemplary claims 51 to 54, wherein a refractive index Δ₂ of the inner cladding region is in the range of about −0.2%Δ to about −0.3%Δ.

Exemplary claim 56. The method of any one of exemplary claims 51 to 55, wherein a refractive index Δ₃ of the trench region is in the range of about −0.25%Δ to about −0.7%Δ.

Exemplary claim 57. The method of any one of exemplary claims 51 to 56, wherein the relative refractive index Δ₃ of the trench region remains substantially constant within the trench region.

Exemplary claim 58. The method of any one of exemplary claims 40 to 57, wherein a refractive index Δ₁ of the core region is in the range of about −0.05%Δ to about 0.05%Δ.

Exemplary claim 59. The method of any one of exemplary claims 40 to 58, wherein a refractive index Δ_{CC} of the common cladding is in the range of about −0.2%Δ to about −0.4%Δ.

Exemplary claim 60. The method of any one of exemplary claims 40 to 59, wherein the core region extends from a central axis to an outer radius r₁, and wherein the outer radius r₁ of the core region is greater than or equal to 3.5 μm and less than or equal to 6 μm.

Exemplary claim 61. The method of exemplary claim 60, wherein the inner-cladding region extends from the outer radius r₁ to an outer radius r₂, and wherein the outer radius r₂ of the inner-cladding region is greater than or equal to 6 μm and less than or equal to 14 μm.

Exemplary claim 62. The method of exemplary claim 61, wherein the trench region extends from the outer radius r₂ to an outer radius r₃, wherein the outer radius r₃ of the trench region is greater than or equal to 7 μm and less than or equal to 20 μm.

Exemplary claim 63. The method of any one of exemplary claims 40 to 62, wherein the outer radius R_{CC} is greater than or equal to 70 μm and less than or equal to 90 μm, or the outer radius R_{CC} is greater than or equal to 75 μm and less than or equal to 90 μm.

Exemplary claim 64. The method of any one of exemplary claims 40 to 63, wherein a co-propagating crosstalk between two adjacent core portions is less than or equal to −50 dB per 100 km of the uncoupled multicore optical fiber.

Exemplary claim 65. The method of any one of exemplary claims 40 to 64, wherein a counter-propagating crosstalk between two adjacent core portions is less than or equal to −50 dB per 100 km of the uncoupled multicore optical fiber.

Exemplary claim 66. The method of any one of exemplary claims 40 to 65, wherein the dispersion at 1550 nm of the at least one core portion is greater than or equal to 18 ps/nm/km and less than or equal to 22 ps/nm/km.

Exemplary claim 67. The method of any one of exemplary claims 40 to 66, wherein the uncoupled multicore optical fiber is configured for transmission over at least one of C band or L band or over one or more wavelengths between 1535 nm and 1625 nm.

Exemplary claim 68. The method of any one of exemplary claims 40 to 67, wherein central axes of adjacent core portions of the plurality of core portions are separated from one another by a minimum separation distance that is greater than or equal to 32 μm and less than or equal to 50 μm, or greater than or equal to 34 μm and less than or equal to 45 μm, greater than or equal to 34 μm and less than or equal to 40 μm.

Exemplary claim 69. The method of any of one of exemplary claims 40 to 68, wherein the first plurality of core portions and the second plurality of core portions are arranged in an alternating manner.

Exemplary claim 70. The method of any one of exemplary claims 40 to 69, wherein the alkali dopant comprises at least one of sodium, potassium, rubidium, and lithium.

Exemplary claim 71. The method of any one of exemplary claims 40 to 70, wherein an average concentration of the alkali dopant in the core portion is greater than or equal to 10 ppm or greater than or equal to 20 ppm and less than or equal to 500 ppm.

Exemplary claim 72. The method of any one of exemplary claims 40 to 71, wherein a combination of the first plurality of core portions and the second plurality of core portions comprises at least 6 core portions, or 6 to 10 core portions, or 6 to 8 core portions.

Exemplary claim 73. The method of any one of claims 40 to 72, wherein at least one of the first plurality of core portions or the second plurality of core portions comprises at least 3 core portions, or 3 to 5 core portions, or 3 to 4 core portions.

Exemplary claim 74. The method of any one of claims 40 to 73, wherein the first plurality of core portions and the second plurality of core portions comprise equal number of core portions.

What is claimed is:

1. An uncoupled multicore optical fiber for counter-propagation transmission, comprising:
a common cladding having a refractive index Δ_{CC} and an outer radius R_{CC} greater than or equal to 70 μm and less than or equal to 95 μm;
a coating encircling and directly contacting the common cladding and extending from the outer radius R_{CC} to an outer radius R_{C} that is greater than or equal to 120 μm and less than or equal to 127.5 μm; and
a plurality of core portions disposed within the common cladding;
wherein at least one core portion of the plurality of core portions comprises:
a central axis;
a core region extending from the central axis, the core region comprising a relative refractive index Δ₁ relative to pure silica, wherein the core region comprises an alkali dopant;
a trench region encircling the core region, the trench region comprising a relative refractive index Δ₃ relative to pure silica, wherein Δ₁>Δ_{CC}>Δ₃;
an attenuation of less than 0.165 dB/km at a wavelength of 1550 nm;
an effective area greater than or equal to 75 μm² and less than or equal to 135 μm² at a wavelength of 1550 nm; and
a cable cutoff wavelength less than or equal to 1530 nm;
wherein the common cladding directly contacts the trench region;
wherein the uncoupled multicore optical fiber has a core multiplicity factor ranging from about 0.028 to about 0.045; and
wherein a counter-propagating crosstalk at 1550 nm between two adjacent core portions is less than or equal to −40 dB per 100 km of the uncoupled multicore optical fiber.

2. The uncoupled multicore optical fiber of claim 1, wherein a radiation loss of the at least one core portion of the plurality of core portions is less than 0.01 dB/km at a wavelength of 1550 nm.

3. The uncoupled multicore optical fiber of claim 1, wherein the coating comprises:
a primary coating encircling and directly contacting the common cladding and extending from the outer radius R_{CC} to an outer radius R_{Cp}; and
a secondary coating encircling and directly contacting the primary coating extending from the outer radius R_{Cp} to an outer radius R_{Cs}.

4. The uncoupled multicore optical fiber of claim 3, wherein a ratio of a thickness of the secondary coating to a thickness of the primary coating ranges from about 0.7 to about 1.3, or from about 0.8 to about 1.2.

5. The uncoupled multicore optical fiber of claim 3, wherein at least one of a thickness of the primary coating or a thickness of the secondary coating is greater than or equal to 14 μm and less than or equal to 35 μm.

6. The uncoupled multicore optical fiber of claim 3, wherein the in-situ modulus of the primary coating is greater than or equal to 0.15 MPa and less than or equal to 0.4 MPa, and wherein the in-situ modulus of the secondary coating is greater than or equal to 1,600 MPa and less than or equal to 2,400 MPa.

7. The uncoupled multicore optical fiber of claim 1, wherein the outer radius R_{CC} is greater than or equal to 70 μm and less than or equal to 90 μm, or greater than or equal to 75 μm and less than or equal to 90 μm.

8. The uncoupled multicore optical fiber of claim 1, wherein the plurality of core portions comprises at least 6 core portions, or 6 to 10 core portions, or 6 to 8 core portions.

9. The uncoupled multicore optical fiber of claim 1, wherein the trench region has a trench volume greater than or equal to 5%Δ micron² and less than or equal to 60%Δ micron².

10. The uncoupled multicore optical fiber of claim 1, wherein the effective area of the at least one core portion of the plurality of core portions is greater than or equal to 100 μm² and less than or equal to 125 μm² at a wavelength of 1550 nm.

11. The uncoupled multicore optical fiber of claim 1, wherein a counter-propagating crosstalk at 1550 nm between two adjacent core portions is less than or equal to −50 dB per 100 km of the uncoupled multicore optical fiber.

12. The uncoupled multicore optical fiber of claim 1, wherein the dispersion at 1550 nm of the at least one core portion of the plurality of core portions is greater than or equal to 18 ps/nm/km and less than or equal to 22 ps/nm/km.

13. The uncoupled multicore optical fiber of claim 1, wherein central axes of adjacent core portions of the plurality of core portions are separated from one another by a minimum separation distance that is greater than or equal to 32 μm and less than or equal to 50 μm, or greater than or equal to 34 μm and less than or equal to 45 μm, or greater than or equal to 34 μm and less than or equal to 40 μm.

14. The uncoupled multicore optical fiber of claim 1, wherein the at least one core portion of the plurality of core portions is configured for transmission over at least one of C band or L band.

15. A bidirectional transmission system, comprising:
an uncoupled multicore optical fiber of claim 1;
a first transceiver optically coupled to a first end of the uncoupled multicore optical fiber; and
a second transceiver optically coupled to a second end of the uncoupled multicore optical fiber opposite the first end of the uncoupled multicore optical fiber;
wherein the first transceiver and the second transceiver are configured to transmit signals from the first end of the uncoupled multicore optical fiber to the second end of the uncoupled multicore optical fiber via a first plurality of core portions of the uncoupled multicore optical fiber;
wherein the first transceiver and the second transceiver are further configured to transmit signals from the second end of the uncoupled multicore optical fiber to the first end of the uncoupled multicore optical fiber via a second plurality of core portions of the uncoupled multicore optical fiber; and
wherein the first plurality of core portions of the uncoupled multicore optical fiber is different from the second plurality of core portions of the uncoupled multicore optical fiber.

16. The bidirectional transmission system of claim 15, wherein at least one of the first plurality of core portions or the second plurality of core portions is configured for transmitting signals over C band and L band simultaneously.

17. A method of bidirectional transmission over a multicore optical fiber having a first plurality of core portions and a second plurality of core portions, the method comprising:
transmitting a first optical signal over at least one core portion of the first plurality of core portions in a first direction, wherein at least one core portion of the first plurality of core portions comprises:
a core region comprising an alkali dopant; and
an attenuation of less than 0.165 dB/km at a wavelength of 1550 nm;
transmitting a second optical signal over at least one core portion of the second plurality of core portions in a second direction opposite the first direction, wherein at least one core portion of the second plurality of core portions comprises:
a core region comprising an alkali dopant; and
an attenuation of less than 0.165 dB/km at a wavelength of 1550 nm;
wherein the first plurality of core portions and the second plurality of core portions are disposed within a common cladding having an outer radius R_{CC} greater than or equal to 70 μm and less than or equal to 95 μm;
wherein the multicore optical fiber further comprises a coating encircling and directly contacting the common cladding, wherein an outer radius R_{C} of the coating is greater than or equal to 120 μm and less than or equal to 127.5 μm;
wherein the multicore optical fiber has a core multiplicity factor ranging from about 0.028 to about 0.045; and
wherein a counter-propagating crosstalk at 1550 nm between two adjacent core portions is less than or equal to −40 dB per 100 km of the uncoupled multicore optical fiber.

18. The method of claim 17, further comprising at least one of:
transmitting a third optical signal over the at least one core portion of the first plurality of core portions in the first direction; or
transmitting a fourth optical signal over the at least one core portion of the second plurality of core portions in the second direction;
wherein:
one of the first optical signal and the third optical signal is transmitted over C band;
the other one of the first optical signal and the third optical signal is transmitted over L band;
one of the second optical signal and the fourth optical signal is transmitted over C band; and
the other one of the second optical signal and the fourth optical signal is transmitted over L band.

19. The method of claim 17, wherein the first plurality of core portions and the second plurality of core portions are arranged in an alternating manner.

20. The method of claim 17, wherein at least one of the first plurality of core portions or the second plurality of core portions comprises at least 3 core portions, or 3 to 5 core portions, or 3 to 4 core portions.
